(19) United States
(12) Patent Application Publication
(10) Pub. No.: US 2026/0303319 A1
(43) Pub. Date: Oct. 1, 2026

(54) COMMUNICATION APPARATUS AND COMMUNICATION METHOD

(71) Applicant: MegaChips Corporation, Osaka-shi (JP)

(72) Inventor: Yongwi KIM, Osaka-shi (JP)

(73) Assignee: MegaChips Corporation, Osaka-shi (JP)

(21) Appl. No.: 19/530,406

(22) Filed: Feb. 5, 2026

(30) Foreign Application Priority Data
Mar. 27, 2025 (JP) 2025-053106

(51) Int. Cl. H04L 7/02

(52) U.S. Cl. CPC H04L 7/02

(57) ABSTRACT

A communication apparatus includes a sampling circuit, a conversion circuit, a data width conversion circuit, and a resampling circuit. The sampling circuit samples a first transmission signal input at a first transmission rate at a predetermined sampling frequency that is higher than the first transmission rate and is not an integer multiple of the first transmission rate, and outputs sampling data. In receiving the first transmission signal, the data width conversion circuit converts parallel data from the conversion circuit into symbol sequences each including a second integer number of symbols. The second integer is an integer obtained by multiplying a division value, which is obtained by dividing the sampling frequency by the first transmission rate, by a predetermined first integer. The resampling circuit outputs a plurality of symbols of the symbol sequence respectively corresponding to a plurality of symbols of the first transmission signal as resampling data.

### CROSS-REFERENCE TO RELATED APPLICATION

This application claims priority to Japanese Patent Application No. 2025-053106 filed on Mar. 27, 2025, the entire disclosure of which is hereby incorporated herein by reference

### BACKGROUND

Technical Field

The present disclosure relates to a communication apparatus and a communication method.

### Description of the Background Art

WO 2011/151922 discloses a technology related to a communication apparatus.

### SUMMARY

In one embodiment, a communication apparatus includes: a sampling circuit configured to sample a first transmission signal from a first external apparatus input at a predetermined first transmission rate at a predetermined sampling frequency that is higher than the predetermined first transmission rate and is not an integer multiple of the predetermined first transmission rate, and sample a second transmission signal from a second external apparatus input at a second transmission rate the same as the predetermined sampling frequency at the predetermined sampling frequency; a conversion circuit configured to sequentially output data output by the sampling circuit as parallel data; a data width conversion circuit configured to, in receiving the first transmission signal, convert the parallel data into symbol sequences each including a second integer number of symbols, the second integer being an integer obtained by multiplying a division value, which is obtained by dividing the predetermined sampling frequency by the predetermined first transmission rate, by a predetermined first integer; and a resampling circuit configured to output the symbols of one of the symbol sequences at a plurality of sampling points respectively corresponding to a plurality of transmission symbols of the first transmission signal as resampling data of the first transmission signal.

In one embodiment, a communication method includes: sampling a first transmission signal from a first external apparatus input at a predetermined first transmission rate at a predetermined sampling frequency that is higher than the predetermined first transmission rate and is not an integer multiple of the predetermined first transmission rate, and sampling a second transmission signal from a second external apparatus input at a second transmission rate the same as the predetermined sampling frequency at the predetermined sampling frequency by a sampling circuit; sequentially outputting data output from the sampling circuit as parallel data; in receiving the first transmission signal, converting the parallel data into symbol sequences each including a second integer number of symbols, the second integer being an integer obtained by multiplying a division value, which is obtained by dividing the predetermined sampling frequency by the predetermined first transmission rate, by a predetermined first integer; and outputting the symbols of one of the symbol sequences at a plurality of sampling points respectively corresponding to a plurality of transmission symbols of the first transmission signal as resampling data of the first transmission signal.

These and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically illustrating an example of a configuration of a receiving circuit of a communication apparatus according to a first embodiment.

FIG. 2 is a diagram schematically illustrating an example of a first transmission signal and sampling data.

FIG. 3 is a diagram schematically illustrating an example of the first transmission signal, a symbol sequence, and the sampling data.

FIG. 4 is a diagram schematically illustrating another example of the first transmission signal, a symbol sequence, and the sampling data.

FIG. 5 is a diagram schematically illustrating an example of a configuration of a resampling circuit.

FIG. 6 is a diagram schematically illustrating an example of the first transmission signal, a symbol sequence, and a subsequent symbol sequence.

FIG. 7 is a diagram schematically illustrating an example of the first transmission signal, the symbol sequence, and the subsequent symbol sequence.

FIG. 8 is a flowchart illustrating an example of position determination.

FIG. 9 is a flowchart illustrating another example of position determination.

FIG. 10 is a flowchart illustrating another example of position determination.

FIG. 11 is a diagram schematically illustrating an example of sampling points in each of a plurality of symbol sequences when a transmission frequency of the first transmission signal is low.

FIG. 12 is a diagram for describing an operation of a determination unit.

FIG. 13 is a diagram for describing an operation of the determination unit.

FIG. 14 is a diagram illustrating an example of a configuration of a part of the determination unit according to a second embodiment.

FIG. 15 is a diagram schematically illustrating an example of a configuration of the communication apparatus according to a third embodiment.

FIG. 16 is a diagram schematically illustrating a first example of a configuration of the resampling circuit according to a fourth embodiment.

FIG. 17 is a diagram schematically illustrating a second example of a configuration of the resampling circuit according to the fourth embodiment.

### DESCRIPTION OF THE PREFERRED EMBODIMENTS

### First Embodiment

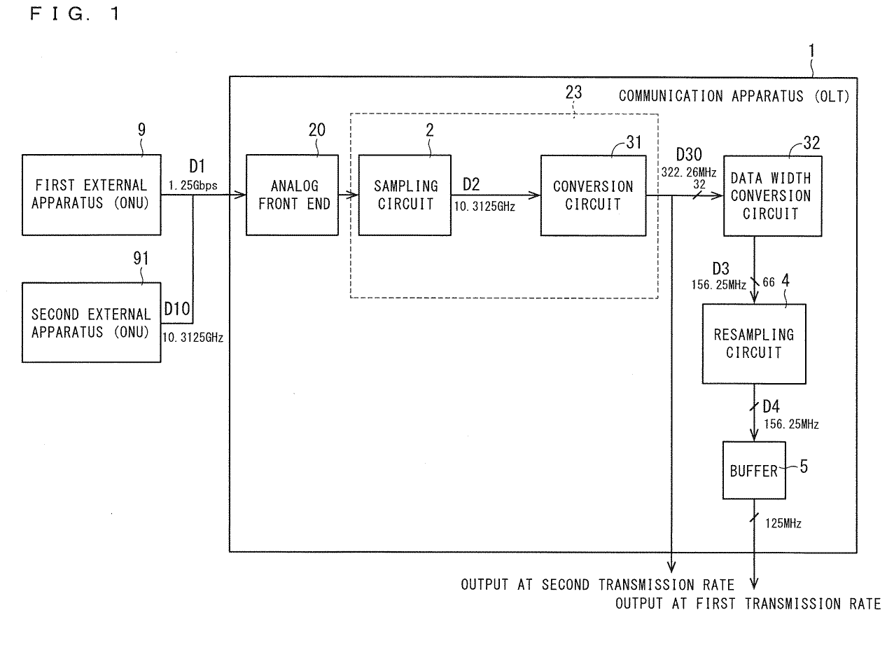

FIG. 1 is a diagram schematically illustrating an example of a configuration of a receiving circuit of a communication apparatus 1 according to a first embodiment. The communication apparatus 1 is connected to a first external apparatus 9 and a second external apparatus 91 via wired or wireless connection, for example. The communication apparatus 1 is provided in a base station, for example. The communication apparatus 1 may be an optical line terminal (OLT). The first external apparatus 9 and the second external apparatus 91 may each be a terminal apparatus on a user side, specifically an optical network unit (ONU), for example. One or more relay apparatuses (not illustrated) may be installed between the communication apparatus 1 and each of the first external apparatus 9 and the second external apparatus 91. The communication apparatus 1 communicates with the first external apparatus 9 and the second external apparatus 91.

The present embodiment will mainly describe a configuration in the communication apparatus 1 for receiving received signals from the first external apparatus 9 and the second external apparatus 91.

The communication apparatus 1 receives a first transmission signal D1 transmitted from the first external apparatus 9 at a first transmission rate, and receives a second transmission signal D10 transmitted from the second external apparatus 91 at a second transmission rate. The first transmission rate and the second transmission rate each indicate the number of symbols per second, and the second transmission rate is higher than the first transmission rate. For example, the first transmission rate is 1.25 Gbps, and the second transmission rate is 10.3125 GHz. The timing at which the first external apparatus 9 transmits the first transmission signal D1 to the communication apparatus 1 and the timing at which the second external apparatus 91 transmits the second transmission signal D10 to the communication apparatus 1 are controlled by the communication apparatus 1, for example. Specifically, the communication apparatus 1 transmits a signal indicating which external apparatus is permitted to perform transmission to the first external apparatus 9 and the second external apparatus 91, and the external apparatus that receives the signal transmits a signal to the communication apparatus 1.

Here, the communication apparatus 1, the first external apparatus 9, and the second external apparatus 91 operate in synchronization with each other. For example, the communication apparatus 1 includes a clock generator (not illustrated), and transmits a transmission signal to the first external apparatus 9 and the second external apparatus 91 based on a clock signal generated by the clock generator. The first external apparatus 9 and the second external apparatus 91 generate a clock signal from the signal transmitted from the communication apparatus 1, and operate based on the clock signal. Accordingly, the communication apparatus 1, the first external apparatus 9, and the second external apparatus 91 can communicate in synchronization. In other words, the communication apparatus 1, the first external apparatus 9, and the second external apparatus 91 can transmit and receive signals with each other at substantially the same frequency. Note that a short-time (for example, instantaneous) frequency variation may occur.

The communication apparatus 1 includes a sampling circuit 2, a conversion circuit 31, a data width conversion circuit 32, and a resampling circuit 4.

Note that the functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

In the example of FIG. 1, the communication apparatus 1 also includes an analog front end 20. The analog front end 20 receives the first transmission signal D1 from the first external apparatus 9 and the second transmission signal D10 from the second external apparatus 91. In other words, when the first external apparatus 9 transmits the first transmission signal D1, the analog front end 20 receives the first transmission signal D1, and when the second external apparatus 91 transmits the second transmission signal D10, the analog front end 20 receives the second transmission signal D10. The analog front end 20 serves as an interface between analog signals on the side of the first external apparatus 9 and the second external apparatus 91 and digital signals of the sampling circuit 2 and its subsequent components. For example, the analog front end 20 includes a filter, a gain adjustment circuit, and the like.

In receiving the first transmission signal D1, the first transmission signal D1 from the analog front end 20 is input to the sampling circuit 2. In other words, the first transmission signal D1 from the first external apparatus 9 is input to the sampling circuit 2 at the first transmission rate. On the other hand, in receiving the second transmission signal D10, the second transmission signal D10 from the analog front end 20 is input to the sampling circuit 2. In other words, the second transmission signal D10 from the second external apparatus 91 is input to the sampling circuit 2 at the second transmission rate. Each of the first transmission signal D1 and the second transmission signal D10 is input to the sampling circuit 2 in serial. Here, each symbol constituting the first transmission signal D1 and the second transmission signal D10 may take a binary value, or may take a multi-value of three or more values. The value of each symbol (hereinafter referred to as a symbol value) takes one of “0” and “1”, for example. In the following, the symbols of the first transmission signal D1 and the second transmission signal D10 are also referred to as transmission symbols.

The sampling circuit 2 samples each of the first transmission signal D1 and the second transmission signal D10 at the same sampling frequency as the second transmission rate, and outputs sampling data D2. Thus, in receiving the second transmission signal D10, the sampling data D2 indicates sampling data of the second transmission signal D10. As an example of a specific operation, the sampling circuit 2 samples the second transmission signal D10 with a synchronous clock signal synchronized with the second transmission signal D10. Accordingly, the sampling circuit 2 can output the sampling data D2, which is obtained by appropriately sampling the second transmission signal D10. In other words, the sampling data D2 includes symbols corresponding to the transmission symbols of the second transmission signal D10 on a one-to-one basis. Note that the synchronous clock signal is generated using a phase adjustment circuit, such as clock data recovery (CDR) (not illustrated), included in the communication apparatus 1, for example.

In this manner, in receiving the second transmission signal D10, the sampling data D2 is sampling data itself of the second transmission signal D10. In other words, because sampling processing has completed, in the example of FIG. 1, the sampling data D2 is output to circuits in a later stage via the conversion circuit 31 that performs serial/parallel conversion to be described later.

On the other hand, also in receiving the first transmission signal D1, the sampling circuit 2 samples the first transmission signal D1 at the same sampling frequency as the second transmission rate. Note that the sampling circuit 2 may be an amplitude symbol conversion circuit that converts amplitude into symbols, such as PAM, and in the present embodiment, an output of the amplitude symbol conversion circuit is also referred to as the sampling data D2.

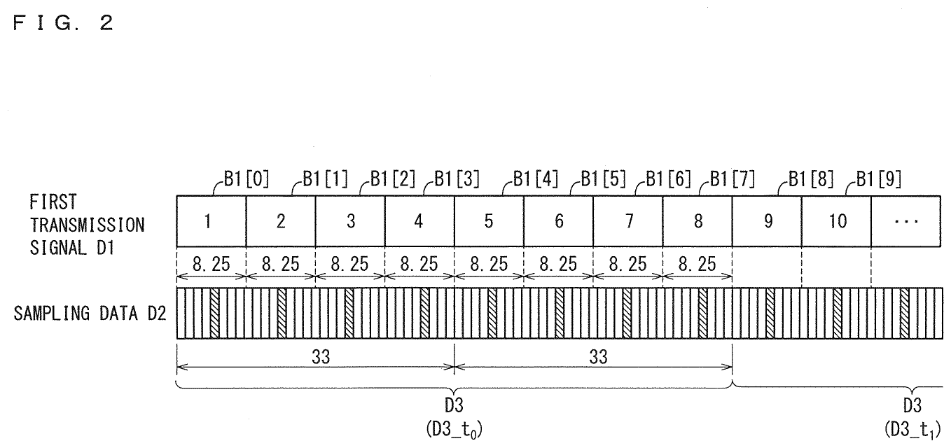

The sampling circuit 2 samples the first transmission signal D1 at the sampling frequency, but a clock signal of the sampling circuit 2 in this case is not synchronized with the first transmission signal D1. The sampling data D2 as described above is not sampling data corresponding to the transmission symbols of the first transmission signal D1 on a one-to-one basis, but is data sampled with a plurality of symbols for one symbol. FIG. 2 is a diagram schematically illustrating an example of the first transmission signal D1 and the sampling data D2. In the example of FIG. 2, each symbol is schematically illustrated as a block. In the example of FIG. 2, the blocks of the first transmission signal D1 are sequentially numbered. The symbols are arranged in time-series order, and a symbol with a smaller number is received by the communication apparatus 1 at an earlier timing.

As illustrated in FIG. 2, the sampling frequency of the sampling data D2 is higher than the frequency of the first transmission signal D1. The sampling frequency (second transmission rate) is higher than the first transmission rate, and is not an integer multiple of the first transmission rate. For example, when the first transmission rate is 1.25 Gbps and the sampling frequency (second transmission rate) is 10.3125 GHz, the sampling frequency is 8.25 times the first transmission rate. In other words, one transmission symbol of the first transmission signal D1 corresponds to 8.25 symbols of the sampling data D2.

A clock signal at the sampling frequency is input to the sampling circuit 2. For example, the communication apparatus 1 may include the clock generator (not illustrated) that generates a clock signal at the sampling frequency. The clock generator may include a crystal oscillator, for example, and may include a micro electro mechanical systems (MEMS) oscillator. In receiving the first transmission signal D1, the clock signal is not subjected to processing using CDR or the like. In other words, in receiving the first transmission signal D1, the clock signal of the clock generator is input to the sampling circuit 2 without passing through the phase adjustment circuit.

The first transmission rate of the first transmission signal D1 and the sampling frequency are not in an integer multiple relationship, and thus timings of the symbols relative to sampling gradually become misaligned. Note that, in the example of FIG. 2, for the sake of better understanding of comparison between the first transmission signal D1 and the sampling data D2, starting points of the first transmission signal D1 and the sampling data D2 are aligned in illustration. The sampling circuit 2 samples the first transmission signal D1 based on the clock signal, and generates the sampling data D2. For example, the sampling circuit 2 may output the first transmission signal D1 at each rise and each fall of the clock signal as the sampling data D2. The sampling circuit 2 outputs the sampling data D2 in serial.

As described above, the sampling circuit 2 once samples the first transmission signal D1 at the sampling frequency that is higher than the first transmission rate and is not an integer multiple of the first transmission rate.

In receiving the first transmission signal D1, the sampling data D2 from the sampling circuit 2 is input to the conversion circuit 31. Specifically, the sampling data D2 is input to the conversion circuit 31 in serial. The conversion circuit 31 converts the input serial data into parallel data D30, and outputs the parallel data D30 to the data width conversion circuit 32. The data width conversion circuit 32 sequentially outputs symbol sequences D3 in parallel, each including a predetermined second integer M2 number of symbols, from the parallel data D30. The second integer M2 is a positive integer satisfying the following expression (1).

$$M 2 = M 1 \cdot SF 1 / TR 1 \qquad ( 1 )$$

Here, M1 represents a positive integer (hereinafter referred to as a first integer), TR1 represents the first transmission rate (for example, a design value) of the first transmission signal D1, and SF1 represents the sampling frequency (for example, a design value). According to expression (1), the number (=second integer M2) of symbols of each symbol sequence D3 is an integer obtained by multiplying a division value (=SF1/TR1), which is obtained by dividing the sampling frequency SF1 by the first transmission rate TR1, by the predetermined first integer M1. For example, when the first transmission rate TR1 is 1.25 Gbps and the sampling frequency SF1 is 10.3125 GHz, the division value (=SF1/TR1) is 8.25. In this case, when the first integer M1 is a multiple of 4, the second integer M2 in expression (1) is a positive integer. As a specific example, when the first integer M1 is 8, the second integer M2 is 66. In the specific examples of FIG. 1 and FIG. 2, the second integer M2 (=number of symbols of each symbol sequence D3) is 66.

The conversion circuit 31 performs serial/parallel conversion on the sampling data D2, and sequentially outputs the converted parallel data D30 to the data width conversion circuit 32. The conversion circuit 31 converts the sampling data D2 into the parallel data D30 including a power-of-two number of symbols, for example. As a more specific example, the conversion circuit 31 outputs the parallel data D30 including 32 symbols.

The data width conversion circuit 32 includes a buffer storage unit (for example, a memory), and stores the sequentially input parallel data D30. The data width conversion circuit 32 receives data in time-series order and outputs data in time-series order (first in first out (FIFO)). The data width conversion circuit 32 sequentially outputs the symbol sequences D3 each including the second integer M2 (for example, 66) number of temporally consecutive symbols from a symbol group stored in the buffer storage unit.

As can be understood from FIG. 2, ideally, each symbol sequence D3 corresponds to the first integer M1 (for example, 8) number of symbols of the first signal D1 (that is, signal transmitted by first external apparatus). In the following, the transmission symbols of the first transmission signal D1 are also referred to as transmission symbols B1. Each of the transmission symbols B1 of the first transmission signal D1 is also referred to as the transmission symbol B1[i]. In the example of FIG. 2, the data width conversion circuit 32 outputs a symbol sequence D3_t₀ as the symbol sequence D3 including 66 symbols corresponding to eight transmission symbols B1, i.e., the transmission symbol B1[0] to the transmission symbol B1[7], of the first transmission signal D1, and outputs a symbol sequence D3_t₁ as the symbol sequence D3 including 66 symbols corresponding to the transmission symbol B1[8] to the transmission symbol B1[15] of the first transmission signal D1. A symbol sequence D3_tₙ (n is an integer) is a subsequent symbol sequence D3 following a symbol sequence D3_tₙ₋₁.

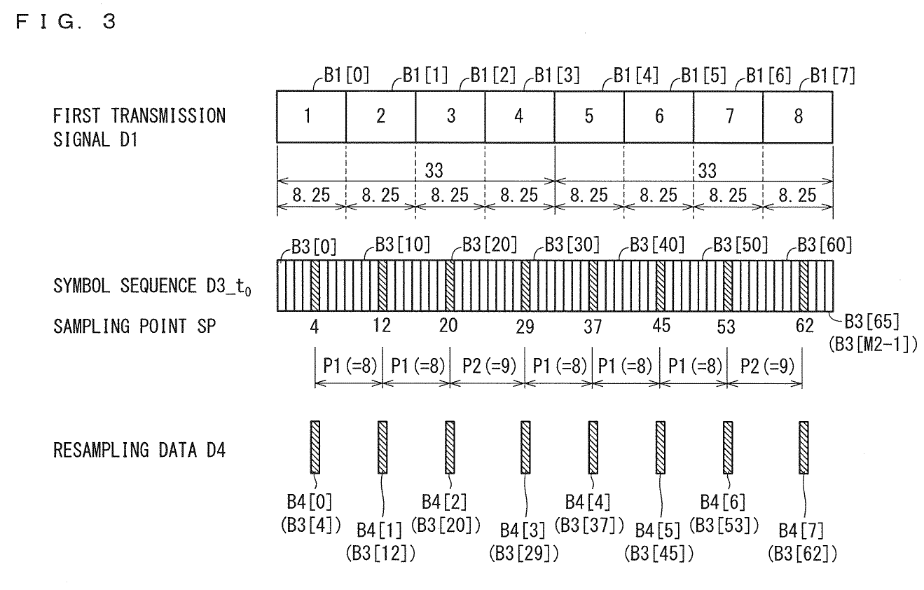

The symbol sequences D3 are sequentially input to the resampling circuit 4. Specifically, the second integer M2 number of symbols of the symbol sequences D3 may be input to the resampling circuit 4 in parallel. The resampling circuit 4 samples data from the symbol sequence D3 and outputs resampling data D4, which may be corresponding transmission symbols B1. FIG. 3 is a diagram schematically illustrating an example of the first transmission signal D1, the symbol sequence D3, and the resampling data D4. In the following, the symbols of the symbol sequence D3 are also referred to as symbols B3, and each of the symbols B3 is also referred to as the symbol B3[j] (0≤j≤M2). The symbols of the resampling data D4 are also referred to as symbols B4, and each of the symbols B4 is also referred to as the symbol B4[k]. A symbol position (i.e., a sampling point) of each symbol B3 of the symbol sequence D3 output as the resampling data D4 is also referred to as a sampling point SP.

As described above, ideally, each symbol sequence D3 corresponds to the first integer M1 (for example, 8) number of transmission symbols B1 of the first transmission signal D1. Thus, ideally, the resampling circuit 4 outputs the resampling data D4 including the first integer M1 number of symbols B3 of the symbol sequence D3 respectively corresponding to the first integer M1 number of transmission symbols B1. In the examples of FIG. 2 and FIG. 3, examples of the symbols B3 corresponding to the respective transmission symbols B1 are schematically illustrated in hatched blocks.

In the examples of FIG. 2 and FIG. 3, the transmission symbol B1[0] mainly corresponds to the symbol B3[0] to the symbol B3[7] of the symbol sequence D3. Thus, the resampling circuit 4 outputs one predetermined symbol B3 among the symbol B3[0] to the symbol B3[7] as the symbol B4[0]. In other words, one of 0 to 7 is employed as the sampling point SP of the transmission symbol B1[0]. As an example, the resampling circuit 4 may output the symbol B3[4] as the symbol B4[0]. In other words, 4 may be employed as the sampling point SP of the transmission symbol B1[0].

Similarly to the transmission symbol B1[0], the resampling circuit 4 outputs predetermined symbols B3 respectively corresponding to the transmission symbol B1[1] to the transmission symbol B1[7] as the symbol B4[1] to the symbol B4[7]. In other words, the resampling circuit 4 outputs the symbols B3 respectively corresponding to the transmission symbol B1[0] to the transmission symbol B1[7] as the symbol B4[0] to the symbol B4[7]. The resampling circuit 4 outputs the symbol B4[0] to the symbol B4[7] in parallel as the resampling data D4.

Incidentally, because one transmission symbol B1 corresponds to a division value (for example, 8.25) number of symbols B3, it is considered that the symbols B3 of the symbol sequence D3 roughly at intervals of the division value are employed as the symbols B4. Note that, because the division value is not an integer, the intervals between the symbols B3 employed as the symbols B4 are not constant. In other words, the intervals between the sampling points SP are not constant. Here, each of the intervals between the sampling points SP refers to a difference between adjacent sampling points SP. The intervals between the sampling points SP are set to satisfy a condition that the sampling points SP correspond to the respective transmission symbols B1 of the first transmission signal D1.

For example, as long as the condition is satisfied, the intervals between the sampling points SP may include first intervals P1 each being smaller than the division value and second intervals P2 each being larger than the division value. In other words, the resampling data D4 includes the symbols B3 of the symbol sequence D3 at the plurality (for example, all) of sampling points SP including symbol positions being adjacent at the first intervals P1 and symbol positions being adjacent at the second intervals P2. According to this, an average interval between the sampling points SP in the symbol sequence D3 can be brought closer to the division value. In other words, the average interval between the sampling points SP can be brought closer to the division value (for example, 8.25), as compared to a case in which each interval between the sampling points SP in the symbol sequence D3 is only the first interval P1 or the second interval P2. Thus, the resampling circuit 4 can more appropriately output the symbols B3 corresponding to the transmission symbols B1 of the first transmission signal D1.

For example, the first interval P1 may be an integer part (for example, 8) of the division value, and the second interval P2 may be an integer (for example, 9) obtained by rounding up the first decimal place of the division value. In this case, it can also be said that the second interval P2 is an integer obtained by adding 1 to the first interval P1. According to this, variation in the intervals between the sampling points SP can be reduced.

Here, an example of a ratio between the number of first intervals P1 and the number of second intervals P2 between the sampling points SP will be described. Here, the intervals between the sampling points SP also including intervals between the lowest sampling point SP of one symbol sequence D3 and a highest sampling point SP of a subsequent symbol sequence D3 will be described. In other words, the intervals between the sampling points SP when a plurality of symbol sequences D3 are combined to chronological order will be described. The second interval P2 may appear once every four times. In other words, the ratio between the first intervals P1 and the second intervals P2 may be 3:1. In more general terms, the ratio between the number of first intervals P1 and the number of second intervals P2 may be a ratio between a value obtained by subtracting a fractional part of the division value from 1 (1−fractional part) and the fractional part. For example, when the division value is 8.25, the ratio is 0.75 (=1−fractional part):0.25 (=fractional part), i.e., 3:1. According to this, the average interval between the sampling points SP in the symbol sequence D3 can be made to match the division value. Note that, when the intervals between the sampling points SP in the symbol sequence D3 are understood including an interval between the lowest sampling point SP of the symbol sequence D3 and the highest sampling point SP of the subsequent symbol sequence D3, the number of intervals between the sampling points SP in the symbol sequence D3 is the first integer M1. Under this definition, the second interval P2 may appear once every four times in each symbol sequence D3, and the ratio between the number of first intervals P1 and the number of second intervals P2 may be a ratio between a value obtained by subtracting the fractional part of the division value from 1 (1−fractional part) and the fractional part.

For example, the resampling circuit 4 outputs preset symbols B3 at the sampling points SP, which are, as a specific example, the symbol B3[4], the symbol B3[12], the symbol B3[20], the symbol B3[29], the symbol B3[37], the symbol B3[45], the symbol B3[53], and the symbol B3[62], in parallel as the resampling data D4. In other words, in this specific example, the symbol B3[4], the symbol B3[12], the symbol B3[20], the symbol B3[29], the symbol B3[37], the symbol B3[45], the symbol B3[53], and the symbol B3[62] of the symbol sequence D3 correspond to the symbol B4[0] to the symbol B4[7] of the resampling data D4.

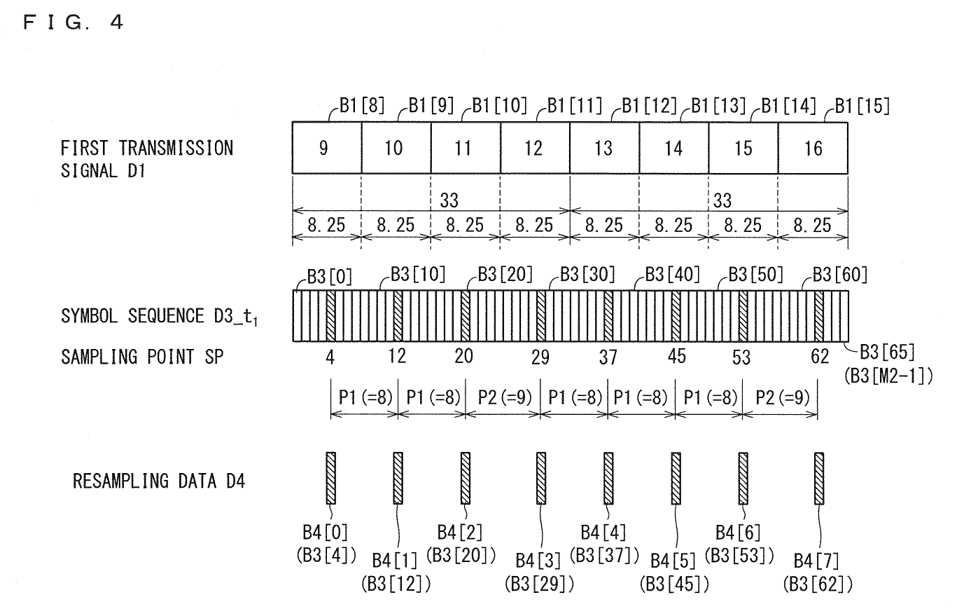

FIG. 4 is a diagram schematically illustrating another example of the first transmission signal D1, the symbol sequence D3, and the resampling data D4. The symbol sequence D3_t₁ of FIG. 4 corresponds to a subsequent symbol sequence D3 following the symbol sequence D3_t₀ of FIG. 3. The symbol sequence D3_t₀ of FIG. 3 corresponds to the first integer M1 (for example, 8) number of transmission symbols B1, i.e., the transmission symbol B1[0] to the transmission symbol B1[7], of the first transmission signal D1, and the symbol sequence D3_t₁ of FIG. 4 corresponds to the first integer M1 (for example, 8) number of transmission symbols B1, i.e., the transmission symbol B1[8] to the transmission symbol B1[15], of the subsequent first transmission signal D1. As described above, because the symbol sequences D3 each correspond to an integer number of transmission symbols B1, all of the sampling points SP can be commonly shared with both FIG. 3 and FIG. 4. For example, the sampling points SP at the same positions are employed in both of the symbol sequence D3_t₁ and the symbol sequence D3_t₀. Accordingly, the resampling circuit 4 can similarly set the plurality of sampling points SP in each of the plurality of sequentially input symbol sequences D3. This can make it unnecessary to reset the plurality of sampling points SP.

In the example of FIG. 1, the communication apparatus 1 also includes a buffer circuit 5. The resampling data D4 is sequentially input to the buffer circuit 5 from the resampling circuit 4. The buffer circuit 5 includes the buffer storage unit (for example, a memory), and stores the resampling data D4 which is sequentially input. The buffer circuit 5 receives data in time-series order and outputs data in time-series order (FIFO). The buffer circuit 5 sequentially outputs sampling data including a predetermined number (for example, 10) of temporally consecutive symbols of the resampling data D4 which is sequentially input. In other words, while the number of symbols of the resampling data D4 output by the resampling circuit 4 is 8 for the sake of appropriate resampling in the resampling circuit 4, the buffer circuit 5 converts the number of symbols into a desired number (for example, 10) of symbols to be used in a later stage.

As described above, in the communication apparatus 1 according to the first embodiment, in receiving the second transmission signal D10 at the second transmission rate, the sampling circuit 2 samples the second transmission signal D10 at the same sampling frequency as the second transmission rate, and generates the sampling data D2 including symbols corresponding to the symbols of the second transmission signal D10 on a one-to-one basis.

On the other hand, in receiving the first transmission signal D1 at the first transmission rate, the sampling circuit 2 once samples the first transmission signal D1 at the sampling frequency that is higher than the first transmission rate and is not an integer multiple of the first transmission rate, the conversion circuit 31 converts the sampling data D2 into the parallel data D30 and outputs the parallel data D30, the data width conversion circuit 32 converts the parallel data D30 into the symbol sequences D3 each including M2 symbols and sequentially outputs the symbol sequences D3, and the resampling circuit 4 outputs resampling data D4 from the symbols B3 of the symbol sequence D3, the resampling data D4 is corresponding to the respective transmission symbols B1 of the first transmission signal D1. Consequently, the communication apparatus 1 generates the resampling data D4 corresponding to the symbols of the first transmission signal D1 on a one-to-one basis. According to this sampling method, a large-size phase adjustment circuit (for example, a phase-locked loop circuit) for a clock signal synchronized with the first transmission signal D1 at the first transmission rate is not necessary.

As described above, in the communication apparatus 1, the sampling circuit 2 is used for reception of both of the first transmission signal D1 and the second transmission signal D10, and therefore a chip size can be reduced.

Note that the above-described various configurations included in the communication apparatus 1 may be packaged in any combination. For example, the sampling circuit 2 and the conversion circuit 31 may be packaged. A part including the sampling circuit 2 and the conversion circuit 31 can constitute a serializer (also referred to as a SerDes) 23.

In the example of FIG. 1, both of the analog front end 20 and the conversion circuit 31 are shared in the first transmission signal D1 and the second transmission signal D10, and therefore the circuit scale can be further reduced.

Incidentally, boundaries (edge positions) between the transmission symbols B1 of the first transmission signal D1 may vary on the time axis. For example, the edge positions vary due to a short-time (for example, instantaneous) variation in a transmission frequency of the first transmission signal D1. An increase in such a variation (jitter) in the edge positions may bring the sampling points SP close to the edge positions of the first transmission signal D1. In the case of a sampling point SP close to the edge position, the resampling circuit 4 may wrongly sample the transmission symbol B1. In other words, the variation in the edge positions may hinder the communication apparatus 1 from appropriately sampling the first transmission signal D1. In view of this, it is intended to determine the sampling points SP according to the variation in the edge positions.

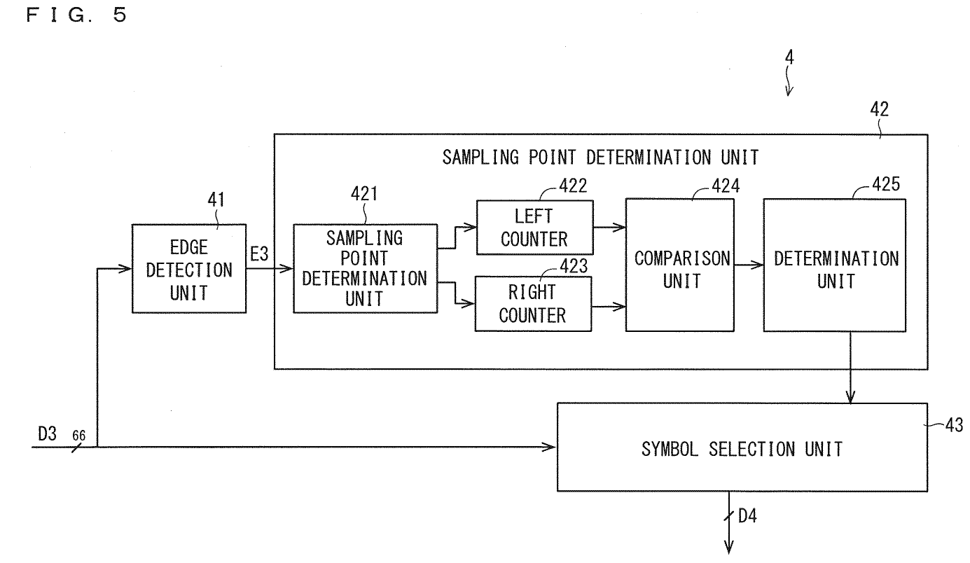

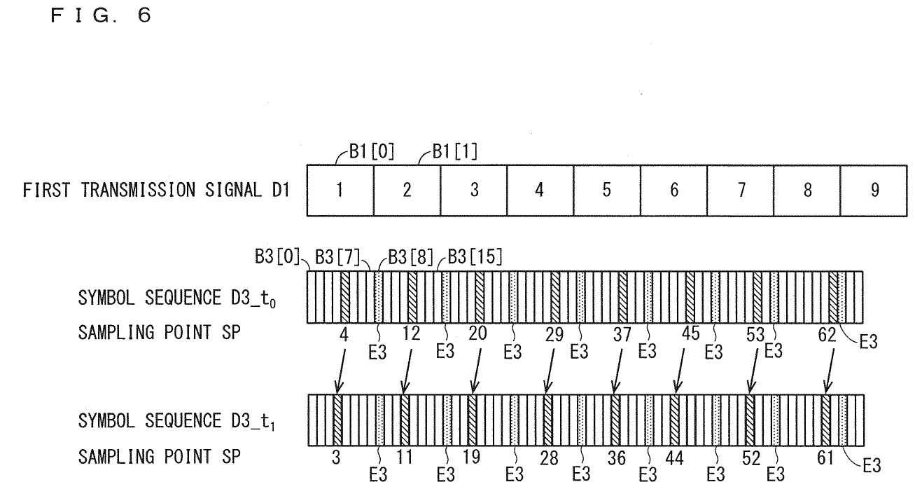

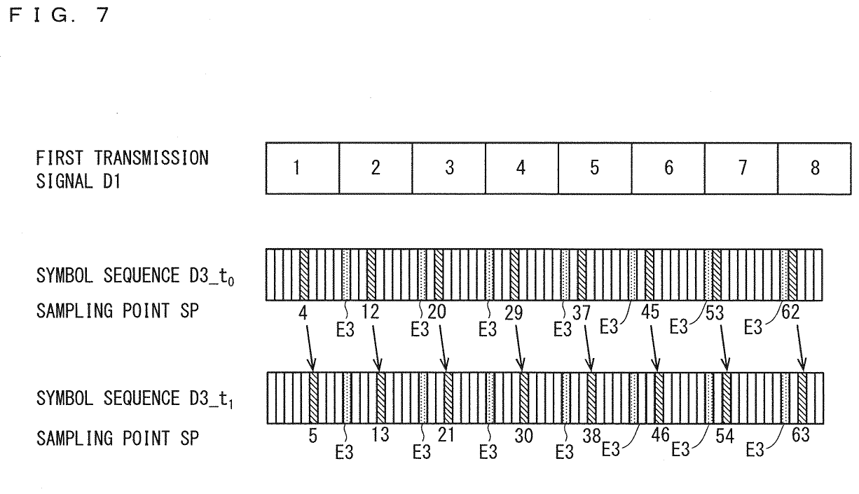

FIG. 5 is a diagram schematically illustrating an example of a configuration of the resampling circuit 4. FIG. 6 and FIG. 7 are each a diagram schematically illustrating an example of the first transmission signal D1, the symbol sequence D3_t₀, and the subsequent symbol sequence D3_t₁. FIG. 6 illustrates an example of a case in which the transmission frequency of the first transmission signal D1 is instantaneously higher than an assumed value, and FIG. 7 illustrates an example of a case in which the transmission frequency of the first transmission signal D1 is instantaneously lower than the assumed value.

The resampling circuit 4 detects edge positions E3 in the symbol sequence D3_tₙ, where values of two adjacent symbols B3 are different, and determines the sampling points SP of a subsequent symbol sequence D3_tₙ₊₁, based on the edge positions E3. As a more specific example, the resampling circuit 4 determines the sampling points SP of the subsequent symbol sequence D3_tₙ₊₁ so that the sampling points SP of the subsequent symbol sequence D3_tₙ₊₁ are away from the respective edge positions E3 by a predetermined interval threshold or more. The resampling circuit 4 may individually adjust the sampling points SP of the symbol sequence D3 according to the edge positions E3, or may uniformly adjust all of the sampling points SP of the symbol sequence D3. The latter example will be described in detail below.

In the example of FIG. 5, the resampling circuit 4 includes an edge detection unit 41, a sampling point determination unit 42, and a symbol selection unit 43. The edge detection unit 41, the sampling point determination unit 42, and the symbol selection unit 43 may also be referred to as an edge detection circuit, a sampling point determination circuit, and a symbol selection circuit, respectively.

First, an overview of functions and operations of each configuration will be described. The edge detection unit 41 detects the edge positions E3 in the symbol sequence D3_tₙ every time the symbol sequence D3_tₙ is input. The sampling point determination unit 42 determines the sampling points SP of the subsequent symbol sequence D3_tₙ₊₁, based on the edge positions E3 in the symbol sequence D3_tₙ detected by the edge detection unit 41. The symbol selection unit 43 selects the symbols B3 from the symbol sequence D3_tₙ by using current sampling points SP that are adjusted by the sampling point determination unit 42 based on previous sampling points SP, and outputs the selected symbols B3 as the resampling data D4. Specific functions and operations of each configuration will be described below.

The edge detection unit 41 compares symbol values of two adjacent symbols B3 (hereinafter referred to as a pair) of the symbol sequence D3_tₙ, for all the pairs. In other words, the edge detection unit 41 compares symbol values of the symbol B3[0] and the symbol B3[1], compares symbol values of the symbol B3[1] and the symbol B3[2], . . . , and compares symbol values of the symbol B3[M2−2] and the symbol B3[M2−1]. When symbol values of a pair are different from each other, the edge detection unit 41 detects the edge positions of the symbols B3 of the pair. For example, when a symbol value of the symbol B3[7] is 1 and a symbol value of the symbol B3[8] is 0, the edge detection unit 41 detects the right symbol B3[8] of the pair as the edge position, for example. Note that the edge detection unit 41 may detect the left symbol B3[7] of the pair as the edge position. The edge detection unit 41 detects all the edge positions E3 in the symbol sequence D3.

The sampling point determination unit 42 determines the sampling points SP of the subsequent symbol sequence D3_tₙ₊₁, based on the edge positions E3 from the edge detection unit 41. For example, the sampling point determination unit 42 determines a positional relationship between candidates of the sampling points SP of the subsequent symbol sequence D3_tₙ₊₁ and the edge positions. As the candidates of the sampling points SP, the sampling points SP of the current symbol sequence D3_tₙ are used, for example. In this case, the sampling point determination unit 42 determines a positional relationship between the sampling points SP of the symbol sequence D3_tₙ and the edge positions.

The sampling point determination unit 42 counts the number of sampling points SP close to the edge positions E3 on the left side, based on the position determination. In the following, the number is referred to as a left shift count value. It can also be said that the left shift count value is the number of sampling points SP each having an interval from one of the edge positions E3 smaller than the interval threshold and being located on the left side of the one of the edge positions E3. Here, the interval threshold is a value in units of symbols, and is preset, for example. The interval threshold is set to 3, for example. In the example of FIG. 6, among the sampling points SP of the symbol sequence D3_t₀, two lowest-side sampling points SP are close to the edge positions E3. Specifically, the lowest-side sampling point SP (62 in FIG. 6) is located on the left side of its closest edge position E3, and an interval between the sampling point SP and the edge position E3 is 1. In the example of FIG. 6, the second lowest sampling point SP (53 in FIG. 6) is located on the left side of its closest edge position E3, and an interval between the sampling point SP and the edge position E3 is 2. Intervals between other sampling points SP and edge positions E3 are each 3 or more. In this case, the sampling point determination unit 42 counts 2 as the left shift count value.

The sampling point determination unit 42 counts the number of sampling points SP close to the edge positions E3 on the right side, based on the position determination. In the following, the number is referred to as a right shift count value. The right shift count value is the number of sampling points SP each having an interval from one of the edge positions E3 smaller than the interval threshold and being located on the right side of the one of the edge positions E3. In the example of FIG. 6, all of the sampling points SP located on the right side of the respective edge positions E3 in the symbol sequence D3 are away from the edge positions E3 by more than the interval threshold. In this case, the sampling point determination unit 42 counts 0 as the right shift count value.

Next, the sampling point determination unit 42 determines the sampling points SP of the subsequent symbol sequence D3_tₙ₊₁, based on a magnitude relationship between the left shift count value and the right shift count value. Specifically, when the left shift count value is larger than the right shift count value, the sampling point determination unit 42 determines the sampling points SP obtained by shifting all of the sampling points SP to the left side as the sampling points SP of the symbol sequence D3_tₙ₊₁. In the example of FIG. 6, the left shift count value is 2 and the right shift count value is 0, and thus the sampling point determination unit 42 shifts all of the sampling points SP to the left side. For example, a shift amount is preset, and in the example of FIG. 6, the shift amount is 1. In other words, the sampling point determination unit 42 determines all of the sampling points SP obtained by shifting all of the sampling points SP to the left side by 1 as the sampling points SP of the subsequent symbol sequence D3_t₁.

In the example of FIG. 7, four lowest sampling points SP of all of the sampling points SP (for example, all of the sampling points SP of the symbol sequence D3_t₀) are located on the right side of their closest edge positions E3. An interval between each of these four sampling points SP and its closest edge position E3 is less than the interval threshold. In this case, the sampling point determination unit 42 counts 4 as the right shift count value. On the other hand, in the example of FIG. 7, all of the sampling points SP located on the left side of the respective edge positions E3 among all of the sampling points SP are away from the edge positions E3 by more than the interval threshold. In this case, the sampling point determination unit 42 counts 0 as the left shift count value.

When the right shift count value is larger than the left shift count value, the sampling point determination unit 42 determines the sampling points SP obtained by shifting all of the sampling points SP to the right side as the sampling points SP of the subsequent symbol sequence D3_tₙ₊₁. In the example of FIG. 7, the shift amount is 1. In other words, the sampling point determination unit 42 determines the sampling points SP obtained by shifting all of the sampling points SP to the right side by 1 as the sampling points SP of the subsequent symbol sequence D3_tₙ₊₁.

When the right shift count value and the left shift count value are equal to each other, the sampling point determination unit 42 does not shift any of the sampling points SP. In other words, the sampling point determination unit 42 determines all of the sampling points SP as they are as the sampling points SP of the subsequent symbol sequence D3_tₙ₊₁.

In the example of FIG. 5, the sampling point determination unit 42 includes an edge position determination unit 421, a left counter 422, a right counter 423, a comparison unit 424, and a determination unit 425.

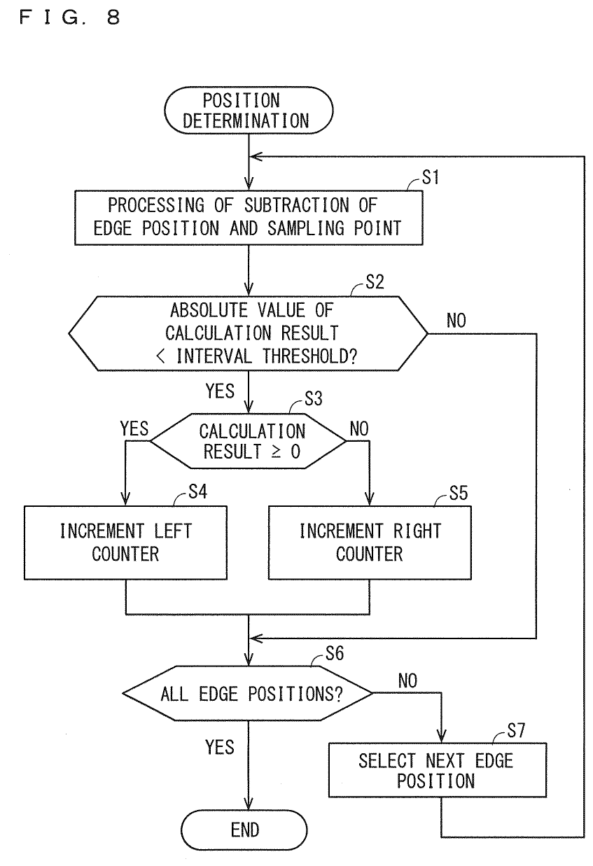

The edge position determination unit 421 performs position determination to be described later related to the positional relationship between the edge positions E3 detected by the edge detection unit 41 and the candidates of the sampling points SP. FIG. 8 is a flowchart illustrating an example of the position determination. In the example of FIG. 8, in Step S1, the edge position determination unit 421 subtracts a position of a corresponding sampling point SP from the edge position E3. For example, the edge position determination unit 421 subtracts the highest sampling point SP from the highest edge position E3.

Next, in Step S2, the edge position determination unit 421 determines whether or not an absolute value of a calculation result of Step S1 is less than the interval threshold.

When the absolute value of the calculation result is less than the threshold, in Step S3, the edge position determination unit 421 determines whether or not the calculation result of Step S1 is equal to or greater than 0.

When the calculation result is equal to or greater than 0, in Step S4, the edge position determination unit 421 causes the left counter 422 to increment the count value. On the other hand, when the calculation result is less than 0, in Step S5, the edge position determination unit 421 causes the right counter 423 to increment the count value.

When the absolute value of the calculation result is equal to or greater than the interval threshold in Step S2, or after Step S4 or Step S5, in Step S6, the edge position determination unit 421 determines whether or not the determination has ended for all of the edge positions E3. If the determination has not yet ended for all of the edge positions E3, in Step S7, the edge position determination unit 421 selects the next edge position E3, and performs the processing of Step S1 to Step S6 on the selected edge position E3. For example, the edge position determination unit 421 selects the second highest edge position E3 in Step S7, subtracts the position of the second sampling point SP from the second edge position in Step S1, and performs Step S2 to Step S6. Similar processing is repeated thereafter.

Then, when the edge position determination unit 421 determines that the determination for all of the edge positions E3 has ended in Step S6, the edge position determination unit 421 ends the determination processing.

When the position determination of the edge position determination unit 421 ends, the comparison unit 424 compares the left shift count value of the left counter 422 and the right shift count value of the right counter 423. Here, the end of the position determination of the edge position determination unit 421 means the end of the determination for all of the edge positions E3.

The determination unit 425 determines the sampling points SP of the subsequent symbol sequence D3_tₙ₊₁, based on a comparison result of the comparison unit 424. When the left shift count value is larger than the right shift count value, the determination unit 425 determines the sampling points SP obtained by shifting all of the sampling points SP to the left side as the sampling points SP of the subsequent symbol sequence D3_tₙ₊₁. In other words, the determination unit 425 determines the sampling points SP obtained by shifting all of the sampling points SP to the left side by the same shift amount as the sampling points SP of the subsequent symbol sequence D3_tₙ₊₁.

When the right shift count value is larger than the left shift count value, the determination unit 425 determines the sampling points SP obtained by shifting all of the sampling points SP to the right side as the sampling points SP of the subsequent symbol sequence D3_tₙ₊₁. In other words, the determination unit 425 determines the sampling points SP obtained by shifting all of the sampling points SP to the right side by the same shift amount as the sampling points SP of the subsequent symbol sequence D3_tₙ₊₁.

When the right shift count value is equal to the left shift count value, the determination unit 425 determines all of the sampling points SP as they are as the sampling points SP of the subsequent symbol sequence D3_tₙ₊₁.

After the position determination, the determination unit 425 instructs the left counter 422 and the right counter 423 to perform initialization and initialize the left shift count value and the right shift count value. In another example, the left counter 422 and the right counter 423 may be overwritten for each symbol sequence D3 and do not need to retain the counter value from the previous symbol sequence. When initialization is required due to the hardware configuration, the determination unit 425 instructs the left counter 422 and the right counter 423 to perform initialization.

The symbol selection unit 43 selects the symbols B3 of the symbol sequence D3_tₙ at previous sampling points SP determined by the sampling point determination unit 42, and outputs the selected symbols B3 as the resampling data D4.

As described above, the resampling circuit 4 detects the edge positions E3 of the symbol sequence D3_tₙ, and determines the plurality of sampling points SP of the subsequent symbol sequence D3_tₙ₊₁, based on the edge positions E3. Thus, the resampling circuit 4 can determine the sampling points SP further away from the edge positions E3 in the subsequent symbol sequence D3_tₙ₊₁. Therefore, the resampling circuit 4 can output the resampling data D4 having higher reliability.

In the specific example described above, the resampling circuit 4 employs the plurality of sampling points SP of the current symbol sequence D3_tₙ as the candidates of the plurality of sampling points SP of the subsequent symbol sequence D3_tₙ₊₁. In other words, the resampling circuit 4 determines the sampling points SP of the subsequent symbol sequence D3_tₙ₊₁, based on the positional relationship between the edge positions E3 and the sampling points SP of the current symbol sequence D3_tₙ. According to this, information of past sampling points SP can be reflected in future sampling points SP, and the sampling points SP can be more appropriately determined.

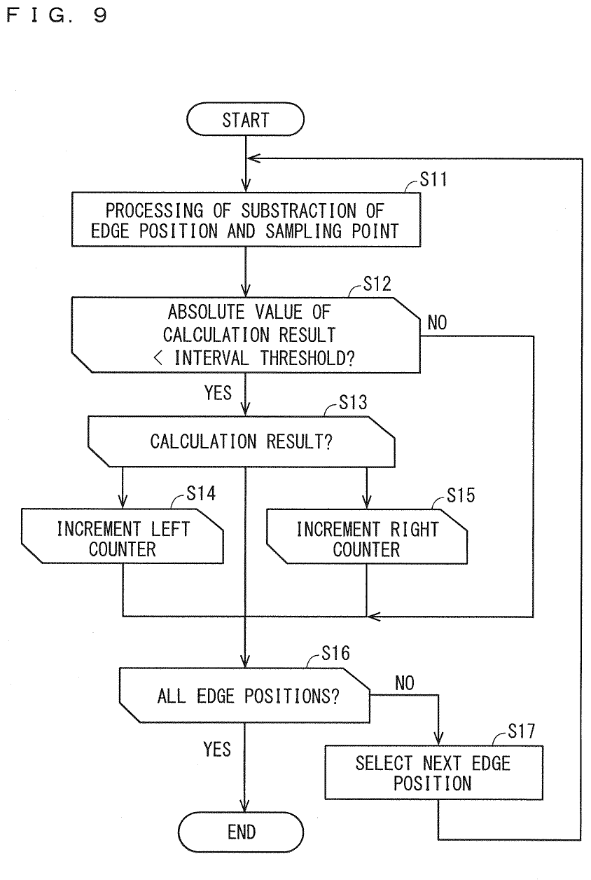

FIG. 9 is a flowchart illustrating another example of the position determination. Steps S1, S2, S4 to S7 are similar to Steps S11, S12, S14 to S17, respectively. In Step S13, the edge position determination unit 421 determines whether the calculation result is greater than 0, less than 0, or equal to 0. When the calculation result is greater than 0, the edge position determination unit 421 performs Step S14. When the calculation result is less than 0, the edge position determination unit 421 performs Step S15. When the calculation result is 0, the edge position determination unit 421 performs Step S16 without Steps S14 and S15.

In the above embodiment, the example calculates the positional relationship between the sampling points SP and the edge positions E3 in a serial manner. However, the process of determining the positional relationship between the sampling points SP and edge positions E3 may also be performed simultaneously for all of the sampling points SP.

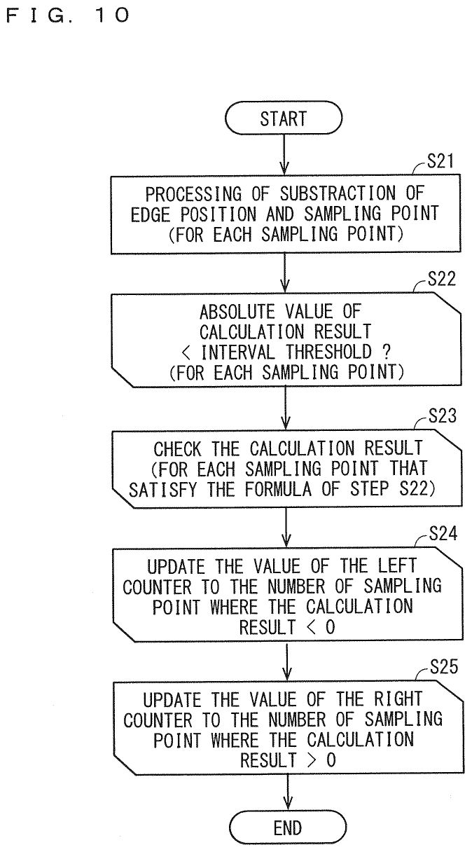

FIG. 10 is a flowchart illustrating another example of the position determination. In the example of FIG. 10, in Step S21, the edge position determination unit 421 subtracts a position of each of the sampling points SP from each of the corresponding edge positions E3, for all the sampling points SP in parallel. For example, the edge position determination unit 421 subtracts the highest sampling point SP from the highest edge position E3. The edge position determination unit 421 subtracts the second highest sampling point SP from the second highest edge position E3. The edge position determination unit 421 performs the subtraction in the same manner as above.

Next, in Step S22, the edge position determination unit 421 determines whether or not each of absolute values of the calculation results of Step S21 is less than the interval threshold, for all the sampling points SP in parallel.

Next, in Step S23, the edge position determination unit 421 determines whether each of the calculation result(s) is greater than 0, less than 0, or equal to 0, for all the sampling points SP determined to be positive in Step S22 in parallel.

In Step S24, the edge position determination unit 421 updates the count value of the left counter 422 to the number of the calculation result(s) determined to be less than 0 in step S23.

In Step S25, the edge position determination unit 421 updates the count value of the right counter 423 to the number of the calculation result(s) determined to be greater than 0 in step S23.

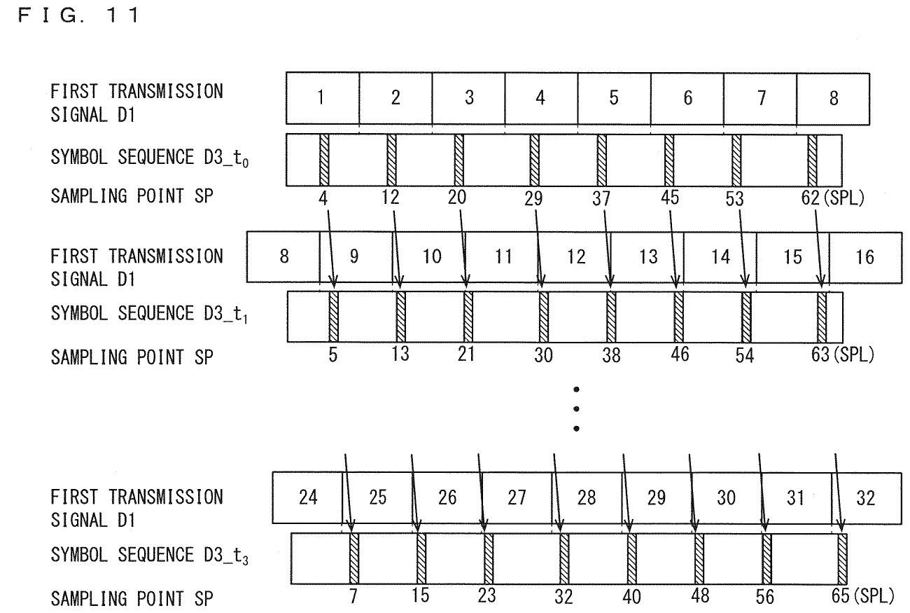

Further consideration will be given to a case in which the transmission frequency of the first transmission signal D1 instantaneously decreases below the assumed value. FIG. 11 is a diagram schematically illustrating an example of the sampling points SP in each of the plurality of symbol sequences D3 when the transmission frequency of the first transmission signal D1 decreases. In the example of FIG. 11, as the plurality of symbol sequences D3, the symbol sequence D3_t₀, the symbol sequence D3_t₁, . . . , and a symbol sequence D3_t₃ are illustrated.

Here, the sampling points SP of the symbol sequence D3_tₙ are also employed as the candidates of the sampling points SP of the subsequent symbol sequence D3_tₙ₊₁.

In the example of FIG. 11, every time the symbol sequence D3 is input, the sampling point determination unit 42 shifts all of the sampling points SP to the right side, based on the edge positions E3 of the first transmission signal D1. For example, the sampling points SP in the symbol sequence D3_t₁ are obtained by respectively uniformly shifting all of the sampling points SP in the symbol sequence D3_t₀ to the right side by a predetermined shift amount. Thus, the rightmost sampling point SP (hereinafter referred to as a lowest point SPL) among all of the sampling points SP eventually reaches the lowest symbol position of the symbol sequence D3. Here, the lowest symbol position of the symbol sequence D3 refers to the rightmost symbol position of the symbol sequence D3. It can also be said that the lowest point SPL is the lowest-side sampling point SP among all of the sampling points SP. When the number (i.e., the second integer M2) of symbols of the symbol sequence D3 is 66, the lowest symbol position corresponds to 65, for example. In the example of FIG. 11, the lowest point SPL in the symbol sequence D3_t₃ is located at the lowest symbol position.

In such a situation in which the lowest point SPL is located at the lowest symbol position of the symbol sequence D3, the lowest point SPL cannot be shifted further to the right side. An example of processing in this situation will be described below.

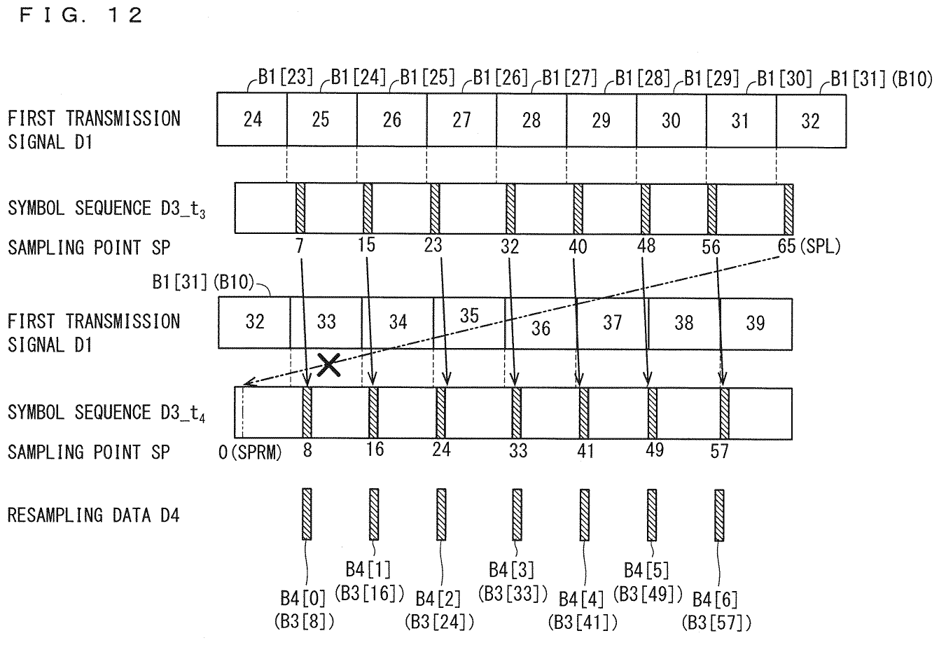

FIG. 12 is a diagram for describing an operation of the determination unit 425. When the sampling point SP after shifting the lowest point SPL is to be located on the right side of the lowest symbol position, the determination unit 425 shifts the lowest point SPL from the lowest symbol position back to the highest symbol position. Here, the highest symbol position refers to the leftmost symbol position of the symbol sequence D3. The highest symbol position is 0, for example.

As a specific example, when the shift amount is 1 and the lowest point SPL being the lowest symbol position of the symbol sequence D3 is to be shifted to the right side, the lowest point SPL is shifted from the lowest symbol position to the highest symbol position (see the two-dot chain line of FIG. 12). In the following, the sampling point SP obtained by shifting the lowest point SPL back to the highest symbol position is also referred to as a wrapped-around high point SPRM.

The resampling circuit 4 does not output the symbol B3 at the wrapped-around high point SPRM in the subsequent symbol sequence D3 (in the figure, a symbol sequence D3_t₄). In other words, the determination unit 425 determines the sampling points SP obtained by shifting the sampling points SP other than the lowest point SPL in the symbol sequence D3_tₙ (in the figure, the symbol sequence D3_t₃) as the sampling points SP of the subsequent symbol sequence D3_tₙ₊₁ (in the figure, the symbol sequence D3_t₄). In other words, the determination unit 425 does not use the wrapped-around high point SPRM as the sampling point SP of the subsequent symbol sequence D3_tₙ₊₁.

In the example of FIG. 12, the symbol with the two-dot chain line indicates that the symbol B3 at the wrapped-around high point SPRM is not output. The symbol selection unit 43 does not output the wrapped-around high point SPRM because the wrapped-around high point SPRM is removed from the next sampling data D4 which is extracted from the subsequent symbol sequence D3_tn+1. In other words, the symbol selection unit 43 outputs the resampling data D4 including (M1−1) (for example, 7) symbols B3 of the symbol sequence D3_tₙ₊1. In the example of FIG. 12, the symbol selection unit 43 respectively outputs the symbol B3[8], the symbol B3[16], the symbol B3[24], the symbol B3[33], the symbol B3[41], the symbol B3[49], and the symbol B3[57] of the symbol sequence D3_t₄ to the buffer circuit 5 as the symbol B4[0] to the symbol B4[6] (i.e., the resampling data D4).

Note that the symbol selection unit 43 may designate addresses of the buffer storage unit of the buffer circuit 5 and output the resampling data D4 thereto, for example. The addresses of the buffer storage unit indicate storage locations of respective symbols B4[k] of the resampling data D4, and the numbers of the addresses are set in order of the symbol positions (i.e., time-series order). Accordingly, the symbol selection unit 43 can cause the buffer storage unit of the buffer circuit 5 to store the resampling data D4 in time-series order.

Here, for comparison, a case in which the determination unit 425 also employs the wrapped-around high point SPRM as the sampling point SP of the subsequent symbol sequence D3 will be described. As illustrated in FIG. 12, in a situation in which the lowest point SPL is located at the lowest symbol position of the symbol sequence D3_t₃, the lowest point SPL corresponds to the transmission symbol B1[31] (hereinafter referred to as a boundary symbol B10). In other words, while the symbol sequence D3_t₃ corresponds to the transmission symbol B1[23] to the transmission symbol B1[31] of the first transmission signal D1, the lowest point SPL corresponds to the lowest-side transmission symbol B1[31] (boundary symbol B10). The boundary symbol B10 is located on the highest side in the subsequent symbol sequence D3_t₄. Accordingly, the wrapped-around high point SPRM also corresponds to the boundary symbol B10 of the subsequent symbol sequence D3_t₄. In other words, both of the lowest point SPL of the symbol sequence D3_t₃ and the wrapped-around high point SPRM of the symbol sequence D3_t₄ correspond to the boundary symbol B10. Thus, if the determination unit 425 employs the wrapped-around high point SPRM as the sampling point SP of the subsequent symbol sequence D3_t₄, the resampling circuit 4 performs duplicate output of two symbols B3 as the boundary symbol B10 of the first transmission signal D1.

In contrast, in the present embodiment, the determination unit 425 does not employ the wrapped-around high point SPRM as the sampling point SP of the subsequent symbol sequence D3_tₙ₊₁, and thus the symbol selection unit 43 does not output the symbol B3 at the wrapped-around high point SPRM in the subsequent symbol sequence D3_tₙ₊₁. Therefore, duplicate output of the symbols B3 for the boundary symbol B10 can be avoided.

Note that the determination unit 425 may determine the sampling points SP of a subsequent symbol sequence D3_t₅ following the symbol sequence D3_t₄, from which the symbol B3 at the wrapped-around high point SPRM is not output, as follows. In other words, the determination unit 425 uses all of the sampling points SP of the current symbol sequence D3_t₄ including the wrapped-around high point SPRM as the candidates of the sampling points SP of the subsequent symbol sequence D3_t₅. In description according to the example of FIG. 12, the determination unit 425 uses the symbol positions “0” (=the wrapped-around high point SPRM), “8”, “16”, “24”, “33”, “41”, “49”, and “57” of the symbol sequence D3_t₄ as the candidates of the sampling points SP of the subsequent symbol sequence D3_t₅. In other words, while the resampling circuit 4 does not output the symbol B3 at the wrapped-around high point SPRM in the symbol sequence D3_t₄, the resampling circuit 4 uses the wrapped-around high point SPRM for calculation of the sampling points SP of the subsequent symbol sequence D3_t₅. Thus, the determination unit 425 obtains the sampling points SP of the subsequent symbol sequence D3_t₅, based on the first integer M1 (for example, 8) number of sampling points SP including the wrapped-around high point SPRM. Accordingly, the resampling circuit 4 outputs the symbols B3 at the first integer M1 number of sampling points SP of the subsequent symbol sequence D3_t₅. Consequently, the resampling circuit 4 can appropriately output the resampling data D4.

Next, a case in which the sampling points SP are shifted to the left side will be described. When the transmission frequency of the first transmission signal D1 instantaneously increases above the assumed value, all of the sampling points SP are shifted to the left side for each symbol sequence D3. Thus, the highest-side sampling point SP (hereinafter referred to as a highest point SPM) among all of the sampling points SP eventually reaches the highest position of the symbol sequence D3. In a situation in which the highest point SPM is located at the highest position of the symbol sequence D3, the highest point SPM cannot be shifted further to the left side.

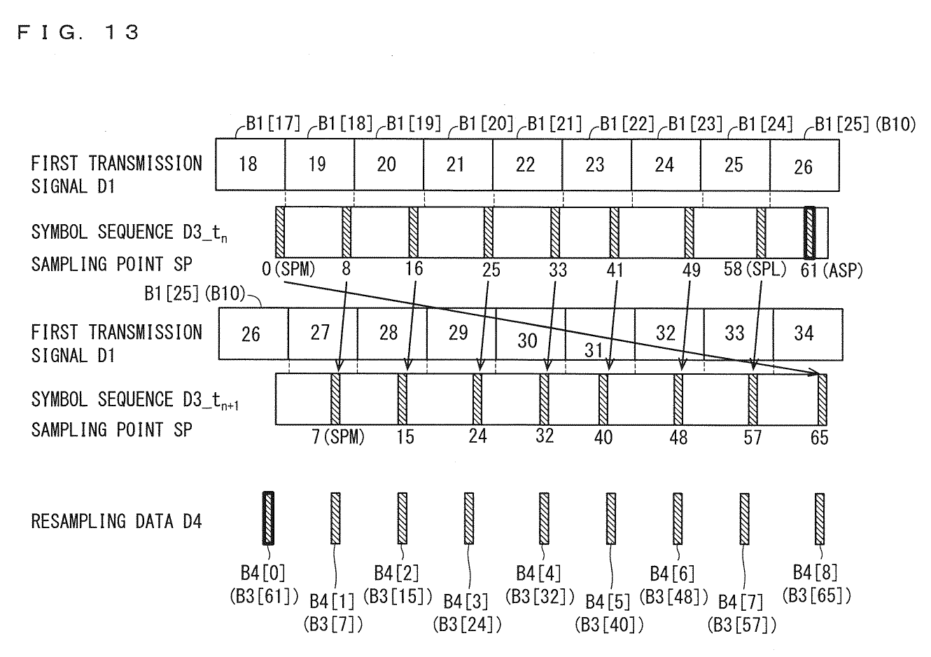

FIG. 13 is a diagram for describing an operation of the determination unit 425. In the example of FIG. 13, in the symbol sequence D3_tₙ, the highest point SPM is located at the highest position. Thus, the sampling point SP after shifting the highest point SPM of the symbol sequence D3_tₙ to the left side is to be located on the left side of the highest symbol position.

In this case, the determination unit 425 shifts the highest point SPM from the highest symbol position back to the lowest symbol position of the subsequent symbol sequence D3_tₙ₊₁. The resampling circuit 4 also outputs the symbol B3 at an additional sampling point ASP of the symbol sequence D3_tₙ described below. The additional sampling point ASP is a symbol position located on the right side of the lowest point SPL in the symbol sequence D3_tₙ, and may be preset, for example. As a specific example, the additional sampling point ASP may be a symbol position (for example, 61) obtained by being shifted from the lowest position (for example, 65) to the left side by approximately half the division value (=SF1/TR1). The resampling circuit 4 includes the buffer storage unit (not illustrated), and stores the symbol B3 at the additional sampling point ASP of the symbol sequence D3 every time the symbol sequence D3 is input, for example.

Then, when the subsequent symbol sequence D3_tₙ₊₁ is input, the resampling circuit 4 outputs the symbol B3 at the additional sampling point ASP of the symbol sequence D3_tₙ and the symbols B3 at the first integer M1 (for example, 8) number of sampling points SP of the symbol sequence D3_tₙ₊₁ as the resampling data D4. Accordingly, the resampling circuit 4 outputs (M1+1) (for example, 9) symbols B3. In the example of FIG. 13, the resampling circuit 4 respectively outputs the symbol B3[61] of the symbol sequence D3_tₙ and the symbol B3[7], the symbol B3[15], the symbol B3[24], the symbol B3[32], the symbol B3[40], the symbol B3[48], the symbol B3[57], and the symbol B3[56] of the symbol sequence D3_tₙ₊₁ as the symbol B4[0] to the symbol B4[8].

Here, for comparison, a case in which the resampling circuit 4 does not output the symbol B3 at the additional sampling point ASP of the symbol sequence D3_tₙ in the subsequent symbol sequence D3_tₙ₊₁ will be described. As illustrated in FIG. 13, in a situation in which the highest point SPM is located at the highest symbol position of the symbol sequence D3_tₙ, the lowest point SPL corresponds to the transmission symbol B1[24], for example. In other words, in the example of FIG. 13, while the symbol sequence D3_tₙ corresponds to the transmission symbol B1[17] to the transmission symbol B1[25] of the first transmission signal D1, the lowest point SPL corresponds to the transmission symbol B1[24], which is one to the left of the lowest-side transmission symbol B1[25] (boundary symbol B10). Thus, none of the sampling points SP in the symbol sequence D3_tₙ corresponds to the boundary symbol B10 (in the figure, the transmission symbol B1[25]). On the other hand, because the transmission frequency of the first transmission signal D1 is higher than the assumed value, the highest point SPM of the subsequent symbol sequence D3_tₙ₊₁ does not correspond to the boundary symbol B10 as well. Thus, the resampling circuit 4 does not output the symbol B3 corresponding to the boundary symbol B10. This causes sampling omission. In other words, in FIG. 13, when the symbol B3[ASP] at the additional sampling point ASP is not output, the symbol B3 corresponding to the boundary symbol B10 (transmission symbol B1[25]) is not output, and this causes sampling omission.

In contrast, in the present embodiment, the resampling circuit 4 stores the symbol B3 at the additional sampling point ASP of the symbol sequence D3_tₙ corresponding to the boundary symbol B10 and also outputs the symbol B3 at the additional sampling point ASP in outputting of the symbols B3 in the subsequent symbol sequence D3_tₙ₊₁. Therefore, output omission of the symbol B3 for the boundary symbol B10 can be avoided.

### Second Embodiment

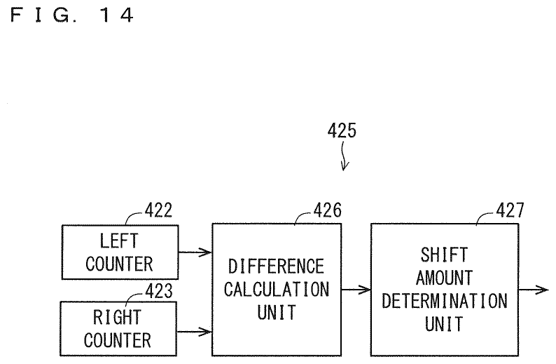

An example of a configuration of the communication apparatus 1 according to a second embodiment is similar to that of the communication apparatus 1 according to the first embodiment. Note that, in the second embodiment, the determination unit 425 determines the shift amount, based on a difference between the right shift count value and the left shift count value. FIG. 14 is a diagram illustrating an example of a configuration of a part of the determination unit 425 according to the second embodiment. The determination unit 425 includes a difference calculation unit 426 and a shift amount determination unit 427.

To the difference calculation unit 426, the left shift count value is input from the left counter 422 and the right shift count value is input from the right counter 423. Here, the left shift count value and the right shift count value are count values after the symbol sequence D3_tₙ is subjected to the position determination. The difference calculation unit 426 calculates an absolute value of the difference between the left shift count value and the right shift count value.

The shift amount determination unit 427 determines the shift amount, based on the absolute value of the difference between the left shift count value and the right shift count value. The shift amount determination unit 427 determines the shift amount to be a larger value as the absolute value of the difference is larger. In other words, the shift amount determination unit 427 determines the shift amount to increase monotonically non-decreasingly with respect to the absolute value of the difference. As a more specific example, the shift amount determination unit 427 determines the shift amount to be 1 when the absolute value of the difference is greater than 0 and equal to or less than 2, determines the shift amount to be 2 when the absolute value of the difference is greater than 2 and equal to or less than 4, and determines the shift amount to be 3 when the absolute value of the difference is greater than 4 and equal to or less than 6.

When the left shift count value is different from the right shift count value, the determination unit 425 shifts the candidates of the plurality of sampling points SP by the shift amount calculated by the shift amount determination unit 427, and obtains the plurality of sampling points SP in the subsequent symbol sequence D3.

According to this, the resampling circuit 4 can output the symbols B3 at the sampling points SP further away from the edge positions E3 in the subsequent symbol sequence D3. Therefore, the resampling circuit 4 can output the resampling data D4 having higher reliability.

### Third Embodiment

In a noisy environment in which the edge positions E3 randomly vary, the noise may be erroneously determined as edges, causing the sampling points SP to be shifted more than necessary. In other words, the sampling points SP may not be stably determined. In view of this, a third embodiment is intended to more stably obtain the sampling points SP.

An example of a configuration of the communication apparatus 1 according to the third embodiment is similar to that of the communication apparatus 1 according to the first embodiment or the second embodiment. Note that, in the third embodiment, based on a result of position determination performed on N (N is an integer of 2 or greater) symbol sequences D3, the determination unit 425 determines the sampling points SP of each of N subsequent symbol sequences D3. In short, in the third embodiment, the determination unit 425 determines the sampling points SP in units of N symbol sequences D3. Thus, the sampling points SP are common among the N symbol sequences D3.

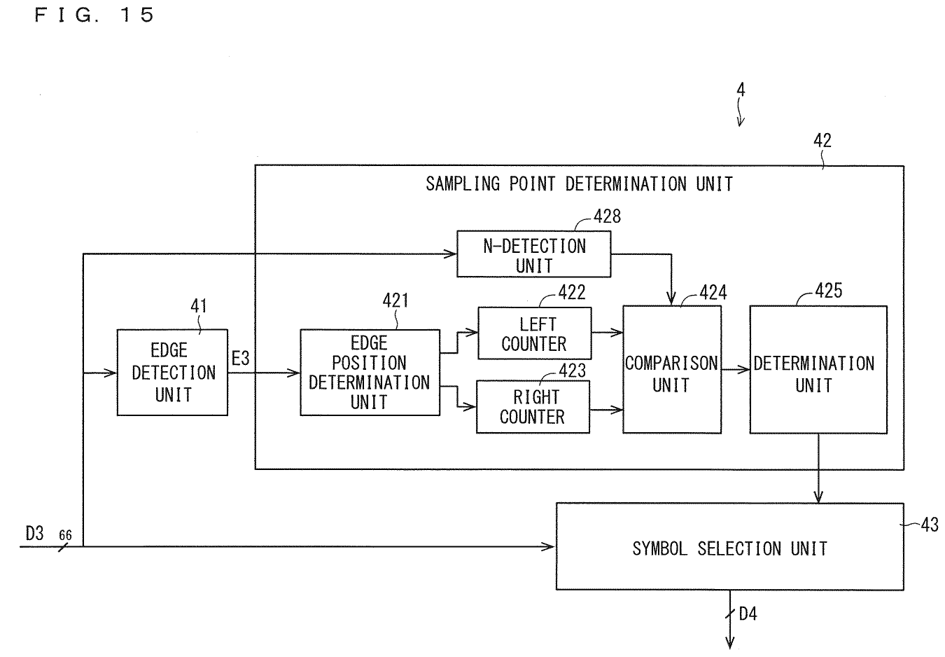

FIG. 15 is a diagram schematically illustrating an example of a configuration of the communication apparatus 1 according to the third embodiment. In the example of FIG. 15, the sampling point determination unit 42 further includes an N-detection unit 428. The N-detection unit 428 detects that N symbol sequences D3 have been input to the resampling circuit 4. For example, the N-detection unit 428 includes a counter, and increments an input count value every time the symbol sequence D3 is input to the resampling circuit 4. When the input count value reaches the number N, the N-detection unit 428 causes the comparison unit 424 to compare the left shift count value and the right shift count value, as will be described later. The N-detection unit 428 initializes the input count value to 0.

On the other hand, every time the symbol sequence D3 is input, the edge detection unit 41 detects the edge positions E3 of the symbol sequence D3. The edge position determination unit 421 performs position determination on the edge positions E3 detected by the edge detection unit 41 and the candidates of the sampling points SP of each of N subsequent symbol sequences D3. The candidates of the sampling points SP of each of N subsequent symbol sequences D3 are the sampling points SP of each of N current symbol sequences D3, for example. The edge position determination unit 421 causes the left counter 422 or the right counter 423 to increment the count value, based on the result of the position determination.

In this manner, every time the symbol sequence D3 is input, detection of the edge positions and position determination are performed, and the left shift count value or the right shift count value is incremented according to the result of the position determination. Accordingly, the left shift count value and the right shift count value indicate the result of the position determination for the plurality of symbol sequences D3.

When the N-detection unit 428 detects an input of N symbol sequences D3, the comparison unit 424 compares the left shift count value and the right shift count value. The left shift count value indicates the sum of sampling points SP each having an interval from the edge position E3 equal to or smaller than a threshold and being located on the left side of the edge position E3 in the N symbol sequences D3. Similarly, the right shift count value indicates the sum of sampling points SP each having an interval from the edge position E3 equal to or smaller than a threshold and being located on the right side of the edge position E3 in the N symbol sequences D3. The comparison unit 424 outputs the comparison result to the determination unit 425.

When the left shift count value is larger than the right shift count value, the determination unit 425 shifts all of the sampling points SP to the left side, and obtains the sampling points SP of each of N subsequent symbol sequences D3. When the left shift count value is smaller than the right shift count value, the determination unit 425 shifts all of the sampling points SP to the right side, and obtains the sampling points SP of each of N subsequent symbol sequences D3. When the left shift count value and the right shift count value are the same, the determination unit 425 determines all of the sampling points SP as they are as the sampling points SP of each of N subsequent symbol sequences D3.

Every time the symbol sequence D3 is input, the symbol selection unit 43 outputs the symbols B3 at the sampling points SP determined by the sampling point determination unit 42.

As described above, in the third embodiment, the sampling points SP of each of N subsequent symbol sequences D3 are determined based on a positional relationship between the edge positions E3 and the sampling points SP of N symbol sequences D3. Thus, in a noisy environment in which the edge positions E3 randomly vary, the sampling point determination unit 42 can more stably obtain the sampling points SP.

Note that, in the specific example described above, the resampling circuit 4 determines the plurality of sampling points SP of N subsequent symbol sequences D3, based on N symbol sequences D3. However, the present embodiment is not necessarily limited to this. For example, the resampling circuit 4 may determine the sampling points SP of M (M is a natural number smaller than N) subsequent symbol sequences D3, based on N symbol sequences D3. For example, M may be 1. In this case, the sampling points SP of the symbol sequence D3_tₙ₊₁ are determined based on immediately preceding N symbol sequences, i.e., a symbol sequence D3_t_{n-N+1} to the symbol sequence D3_tₙ, and the sampling points SP of a symbol sequence D3_tₙ₊₂ are determined based on immediately preceding N symbol sequences, i.e., a symbol sequence D3_t_{n-N+2} to the symbol sequence D3_tₙ₊₁.

### Fourth Embodiment

In a noisy environment in which the edge positions E3 randomly vary, the sampling points SP can be stably determined according to the third embodiment; however, responsiveness of the sampling points SP to the variation in the edge positions E3 decreases. In view of this, a fourth embodiment is intended to stably determine the sampling points SP in a noisy environment and enhance responsiveness of the sampling points SP to the edge positions E3 in a low-noise environment.

An example of a configuration of the communication apparatus 1 according to the fourth embodiment is similar to that of the communication apparatus 1 according to any one of the first to third embodiments. Note that, in the fourth embodiment, the resampling circuit 4 adjusts the number N, based on the first transmission signal D1.

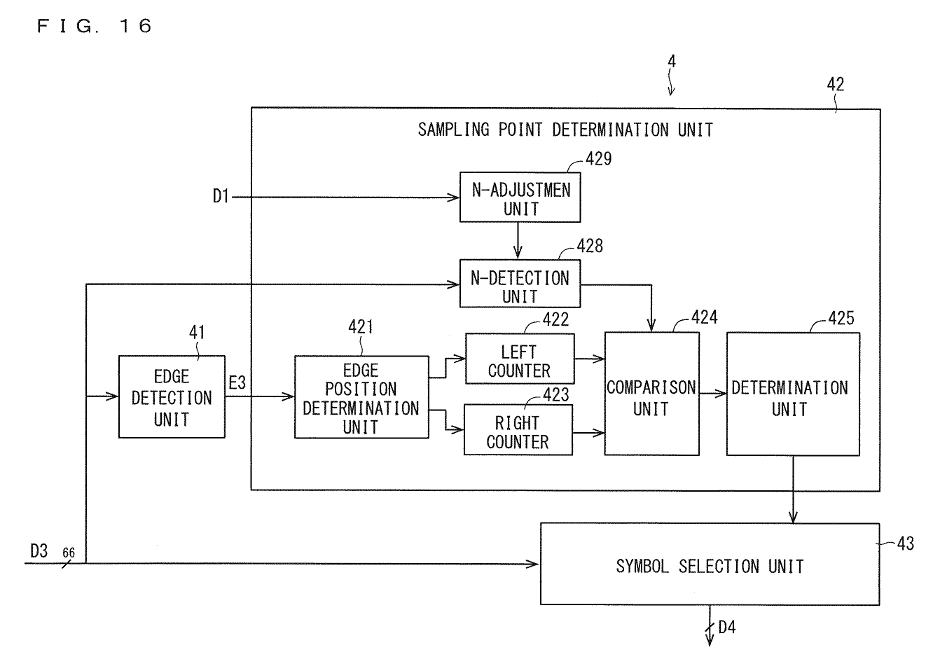

FIG. 16 is a diagram schematically illustrating a first example of a configuration of the resampling circuit 4 according to the fourth embodiment. The resampling circuit 4 further includes an N-adjustment unit 429. The N-adjustment unit 429 determines the number N based on the first transmission signal D1, and outputs the determined number N to the N-detection unit 428.

Incidentally, when amplitude of the first transmission signal D1 is small, a signal-noise ratio (SNR) tends to be low. In other words, a relative noise amount is large. The relatively large noise significantly influences the first transmission signal D1, and the noise may be erroneously determined as edges, causing the sampling points SP to be shifted more than necessary.

Accordingly, the N-adjustment unit 429 determines the number N, based on the amplitude of the first transmission signal D1. Specifically, the N-adjustment unit 429 determines the number N to be large as the amplitude of the first transmission signal D1 is smaller. In other words, the N-adjustment unit 429 decreases the number N monotonically non-increasingly with respect to the amplitude of the first transmission signal D1. As a more specific example, the N-adjustment unit 429 determines the number N when the amplitude of the first transmission signal D1 is equal to or greater than a predetermined amplitude threshold to be smaller than the number N when the amplitude of the first transmission signal D1 is less than the predetermined amplitude threshold. The amplitude threshold is preset, for example.

The analog front end 20 amplifies the amplitude of the first transmission signal D1 with a gain according to the amplitude of the first transmission signal D1. The analog front end 20 amplifies the amplitude of the first transmission signal D1 so that the amplified amplitude of the first transmission signal D1 falls within a predetermined amplitude range, and outputs the amplified first transmission signal D1 to the sampling circuit 2. Such a gain of the analog front end 20 reflects the amplitude of the first transmission signal D1 before being amplified. In other words, as the gain is larger, the amplitude of the first transmission signal D1 before being amplified is smaller. Accordingly, the N-adjustment unit 429 may determine the number N to be large, based on the gain of the analog front end 20.

According to the first example of the communication apparatus 1 according to the fourth embodiment, when the amplitude of the first transmission signal D1 is small, the number N is determined to be large. Consequently, in an environment in which the edge positions are prone to randomly vary, the determination unit 425 determines the sampling points SP in M subsequent symbol sequences D3, based on a larger number N of symbol sequences D3. Therefore, the determination unit 425 can more stably determine the plurality of sampling points SP.

On the other hand, when the amplitude of the first transmission signal D1 is large, the number N is determined to be small. Consequently, in a low-noise environment, the determination unit 425 determines the sampling points SP in M subsequent symbol sequences D3, based on a smaller number N of symbol sequences D3. Therefore, the determination unit 425 can determine the plurality of sampling points SP with high responsiveness to the variation in the edge positions E3. In other words, the sampling points SP can be made to follow the edge positions E3 with higher responsiveness. Therefore, the resampling circuit 4 can more appropriately output the resampling data D4 of the first transmission signal D1.

Because the resampling circuit 4 adjusts the number N according to the amplitude of the first transmission signal D1, the number N can be adjusted with a simpler configuration.

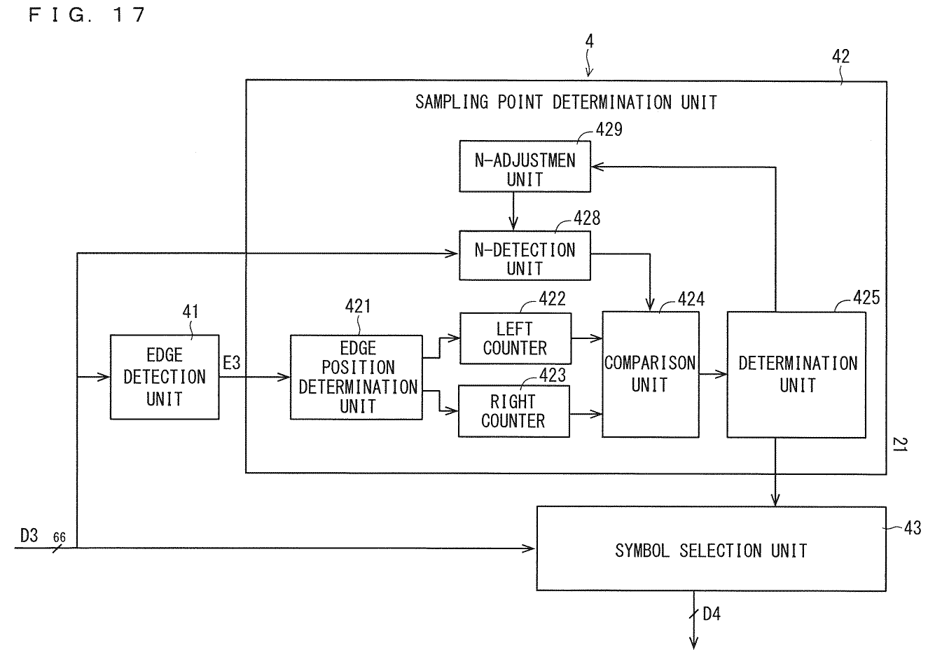

FIG. 17 is a diagram schematically illustrating a second example of a configuration of the resampling circuit 4 according to the fourth embodiment. The N-adjustment unit 429 determines the number N, based on a shift history of past sampling points SP. Specifically, when the N-adjustment unit 429 determines that shift occurrence frequency (described later) is higher than a predetermined occurrence frequency threshold and shift directions are dispersed, the N-adjustment unit 429 increases the number N. Here, the shift occurrence frequency is a ratio of the number of times the candidate of the sampling point SP is shifted to a predetermined number of immediately preceding past position determinations, for example. The occurrence frequency threshold is preset, for example.

Determination as to whether or not the shift directions are dispersed may be performed as described below, for example. Here, variance of an absolute value x of a difference between the left shift count value and the right shift count value is introduced. When an interval of variance (hereinafter referred to as a variance interval) is understood in units of the number of symbol sequences D3, the interval is a sufficiently larger interval (for example, five times or more) than the number N. The variance is expressed by the following expression, for example.

$$σ = ( mean value of x ∧ 2 ) - ( mean value of x ) ∧ 2 \qquad ( 1 )$$

Here, “A\hat{ }B” denotes A raised to the power of B. The mean value used herein indicates a mean value in the variance interval.

As the variance σ is larger, the absolute value x is more dispersed. Accordingly, when the variance σ is large, it is considered that the number N is increased. However, increasing the number N when a frequency offset is large reduces the followability of the sampling points SP with respect to the edge positions E3. Thus, when the frequency offset is large, it is desirable that increasing the number N be avoided. Furthermore, when the frequency offset is large, (mean of x)\hat{ }2 tends to be large.

Accordingly, when (mean of x)\hat{ }2 is less than a first threshold and the variance σ is equal to or greater than a second threshold, the N-adjustment unit 429 determines the number N to be a relatively large first predetermined value.

On the other hand, when (mean of x)\hat{ }2 is equal to or greater than a third threshold, the N-adjustment unit 429 determines the number N to be a relatively small second predetermined value.

According to this, when the shift directions are random, N is determined to be large. For example, the N-adjustment unit 429 determines the relatively large first predetermined value as the number N. Consequently, in an environment in which the edge positions E3 are prone to randomly vary, the determination unit 425 can more stably determine the plurality of sampling points SP.

When the shift directions are continuously the same directions, the N-adjustment unit 429 reduces the number N. For example, when the plurality of sampling points SP are shifted and the shift directions are the same in all of the results of a predetermined number of immediately preceding past position determinations, the N-adjustment unit 429 determines the number N to be the smaller second predetermined value. The second predetermined value is smaller than the first predetermined value, and is preset, for example. Alternatively, when the N-adjustment unit 429 determines that the shift occurrence frequency is higher than the occurrence frequency threshold and the shift directions are the same, the N-adjustment unit 429 may determine the number N to be the small second predetermined value.

In this manner, when the shift directions are uniform, the number N is determined to be small. Consequently, the determination unit 425 can determine the plurality of sampling points SP with high responsiveness to the variation in the edge positions E3.

As described above, while the communication apparatus 1 has been described in detail, the foregoing description is in all aspects illustrative, and the present disclosure is not limited thereto. Various embodiments described above can be applied in combination, on the condition that the combination is consistent. It is therefore understood that numerous unillustrated modifications can be devised without departing from the scope of the communication apparatus 1.

The present disclosure includes the following aspects.

A first aspect is a communication apparatus including: a sampling circuit configured to sample a first transmission signal from a first external apparatus input at a predetermined first transmission rate at a predetermined sampling frequency that is higher than the predetermined first transmission rate and is not an integer multiple of the predetermined first transmission rate, and sample a second transmission signal from a second external apparatus input at a second transmission rate the same as the predetermined sampling frequency at the predetermined sampling frequency; a conversion circuit configured to sequentially output data output by the sampling circuit as parallel data; a data width conversion circuit configured to, in receiving the first transmission signal, convert the parallel data into symbol sequences each including a second integer number of symbols, the second integer being an integer obtained by multiplying a division value, which is obtained by dividing the predetermined sampling frequency by the predetermined first transmission rate, by a predetermined first integer; and a resampling circuit configured to output the symbols of one of the symbol sequences at a plurality of sampling points respectively corresponding to a plurality of transmission symbols of the first transmission signal as resampling data of the first transmission signal.

A second aspect is the communication apparatus according to the first aspect. The resampling circuit outputs the symbols of the one of the symbol sequences at the plurality of sampling points including symbol positions being adjacent at a first interval being an integer smaller than the division value and symbol positions being adjacent at a second interval being an integer larger than the division value as the resampling data.

A third aspect is the communication apparatus according to the second aspect. The first interval is an integer part of the division value, and the second interval is a value obtained by rounding up the division value to a first decimal place.

A fourth aspect is the communication apparatus according to the third aspect. When intervals between the plurality of sampling points are counted also including an interval between a lowest sampling point of the one of the symbol sequences and a highest sampling point of a subsequent one of the symbol sequences, a ratio between a number of the first intervals and a number of the second intervals is a ratio between a value obtained by subtracting a fractional part of the division value from 1 and the fractional part.

A fifth aspect is the communication apparatus according to any one of the first to fourth aspects. The resampling circuit detects edge positions in the one of the symbol sequences, each of the edge positions is a position where values of two adjacent among the symbols are different, and determines the plurality of sampling points of subsequent one of the symbol sequences, based on the edge positions.

A sixth aspect is the communication apparatus according to the fifth aspect. The resampling circuit counts a left shift count value, which is, among candidates of the plurality of sampling points in the subsequent one of the symbol sequences, a number of the candidates each having an interval from one of the edge positions smaller than an interval threshold and being located on a left side of the one of the edge positions. The resampling circuit counts a right shift count value, which is, among the candidates of the plurality of sampling points in the subsequent one of the symbol sequences, the number of the candidates each having the interval from one of the edge positions smaller than the interval threshold and being located on a right side of the one of the edge positions. When the right shift count value is larger than the left shift count value, the resampling circuit determines the plurality of sampling points obtained by shifting the candidates to the right side as the plurality of sampling points of the subsequent one of the symbol sequences. When the left shift count value is larger than the right shift count value, the resampling circuit determines the plurality of sampling points obtained by shifting the candidates to the left side as the plurality of sampling points of the subsequent one of the symbol sequences.

A seventh aspect is the communication apparatus according to the sixth aspect. The resampling circuit uses the plurality of sampling points of a current one of the symbol sequences as the candidates of the plurality of sampling points of the subsequent one of the symbol sequences.

An eighth aspect is the communication apparatus according to the sixth or seventh aspect. When a lowest-side sampling point of the candidates of the plurality of sampling points is to be shifted from a lowest position back to a highest position of the one of the symbol sequences by shifting the candidates of the plurality of sampling points to the right side, the resampling circuit does not output one of the symbols at a highest-side sampling point of the plurality of sampling points in the subsequent one of the symbol sequences.

A ninth aspect is the communication apparatus according to any one of the sixth to eighth aspects. When a highest-side sampling point of the plurality of sampling points is to be shifted from a highest position to a lowest position of the subsequent one of the symbol sequences by shifting the candidates of the plurality of sampling points of the subsequent one of the symbol sequences to the left side, the resampling circuit also outputs one of the symbols at an additional sampling point located on a lower side of a lowest-side sampling point of a current one of the symbol sequences as the resampling data.

A tenth aspect is the communication apparatus according to any one of the sixth to ninth aspects. The resampling circuit shifts the candidates of the plurality of sampling points with a larger shift amount as an absolute value of a difference between the right shift count value and the left shift count value is larger.

An eleventh aspect is the communication apparatus according to any one of the sixth to tenth aspects. The resampling circuit counts the right shift count value and the left shift count value in N (N is an integer of 2 or greater) of the symbol sequences. When the right shift count value is larger than the left shift count value, the resampling circuit determines the plurality of sampling points obtained by shifting the candidates to the right side as the plurality of sampling points of each of M (M is a natural number smaller than N) subsequent ones of the symbol sequences. When the left shift count value is larger than the right shift count value, the resampling circuit determines the plurality of sampling points obtained by shifting the candidates to the left side as the plurality of sampling points of each of the M subsequent ones of the symbol sequences.

A twelfth aspect is the communication apparatus according to the eleventh aspect. The resampling circuit determines a larger value as the N as amplitude of the first transmission signal is smaller.

A thirteenth aspect is the communication apparatus according to the tenth or eleventh aspect. When the resampling circuit determines that shift occurrence frequency of the plurality of sampling points is equal to or greater than an occurrence frequency threshold and shift directions of the plurality of sampling points are dispersed, the resampling circuit increases the N.

A fourteenth aspect is the communication apparatus according to any one of the eleventh to thirteenth aspects. When shift directions of the plurality of sampling points are continuously same, the resampling circuit reduces the N.

A fifteenth aspect is a communication method including: sampling a first transmission signal from a first external apparatus input at a predetermined first transmission rate at a predetermined sampling frequency that is higher than the predetermined first transmission rate and is not an integer multiple of the predetermined first transmission rate, and sampling a second transmission signal from a second external apparatus input at a second transmission rate the same as the predetermined sampling frequency at the predetermined sampling frequency by a sampling circuit; sequentially outputting data output from the sampling circuit as parallel data; in receiving the first transmission signal, converting the parallel data into symbol sequences each including a second integer number of symbols, the second integer being an integer obtained by multiplying a division value, which is obtained by dividing the predetermined sampling frequency by the predetermined first transmission rate, by a predetermined first integer; and outputting the symbols of one of the symbol sequences at a plurality of sampling points respectively corresponding to a plurality of transmission symbols of the first transmission signal as resampling data of the first transmission signal.

According to first and fifteenth aspects, the sampling circuit (sampling function) is commonly used by the first external apparatus and the second external apparatus. In receiving the first transmission signal, sampling with a clock signal synchronized with the first transmission signal is not necessary. Therefore, the circuit scale of the communication apparatus can be reduced. In addition, the number (second integer) of symbols of the symbol sequence corresponds to the predetermined first integer number of symbols of the first transmission signal. Therefore, ideally, the plurality of sampling points may be located at the same positions among the plurality of symbol sequences sequentially input to the resampling circuit. This allows the resampling circuit to easily determine the plurality of sampling points in the plurality of symbol sequences.

According to the second aspect, the average interval between the plurality of sampling points in the symbol sequence can be brought closer to the interval (i.e., the division value) between the plurality of symbols of the first transmission signal. Therefore, the resampling circuit can more appropriately output the symbols corresponding to the symbols of the first transmission signal.

According to the third aspect, variation in the intervals between the sampling points in the symbol sequence can be reduced.

According to the fourth aspect, the average interval between the sampling points in the symbol sequence can be made to match the division value.

According to the fifth aspect, when the sampling points and the edge positions are close, the sampling points can be brought away from the edge positions.

According to the sixth and seventh aspects, the sampling points are adjusted in units of symbol sequences, and therefore time for counting and determination can be sufficiently secured.

According to the eighth aspect, a situation of duplicate output of two pieces of sampling data to one transmission symbol of the first transmission signal can be avoided.

According to the ninth aspect, output omission of the sampling data corresponding to the transmission symbol of the first transmission signal can be avoided.

According to the tenth aspect, the sampling data of the first transmission signal can be more appropriately output.

According to the eleventh aspect, when the edge positions of the first transmission signal randomly vary with high occurrence frequency or the like, the resampling circuit can more stably operate.

According to the twelfth aspect, when the amplitude of the first transmission signal is small, the influence of noise is relatively, and the edge positions are prone to randomly vary. When the amplitude of the first transmission signal is small, the sampling points are determined in units of a larger number of symbol sequences. Therefore, the resampling circuit can more stably operate.

According to the thirteenth aspect, the resampling circuit can more stably output the sampling data.

According to the fourteenth aspect, the sampling points can be made to follow with higher responsiveness according to the variation in the edge positions of the first transmission signal. Therefore, the resampling circuit can appropriately output the sampling data of the first transmission signal.

While the disclosure has been shown and described in detail, the foregoing description is in all aspects illustrative and not restrictive. It is therefore understood that numerous modifications and variations can be devised.

What is claimed is:

1. A communication apparatus comprising:
a sampling circuit configured to sample a first transmission signal at a predetermined sampling frequency and sample a second transmission signal at the predetermined sampling frequency, the first transmission signal input from a first external apparatus at a predetermined first transmission rate, the predetermined sampling frequency being higher than the predetermined first transmission rate and being not an integer multiple of the predetermined first transmission rate, the second transmission signal input from a second external apparatus at a second transmission rate the same as the predetermined sampling frequency;
a conversion circuit configured to sequentially output data output by the sampling circuit as parallel data;
a data width conversion circuit configured to, in receiving the first transmission signal, convert the parallel data into symbol sequences each including a second integer number of symbols, the second integer being an integer obtained by multiplying a division value, which is obtained by dividing the predetermined sampling frequency by the predetermined first transmission rate, by a predetermined first integer; and
a resampling circuit configured to output the symbols of one of the symbol sequences at a plurality of sampling points respectively corresponding to a plurality of transmission symbols of the first transmission signal as resampling data of the first transmission signal.

2. The communication apparatus according to claim 1, wherein
the resampling circuit outputs the symbols of the one of the symbol sequences at the plurality of sampling points including symbol positions being adjacent at a first interval being an integer smaller than the division value and symbol positions being adjacent at a second interval being an integer larger than the division value as the resampling data.

3. The communication apparatus according to claim 2, wherein
the first interval is an integer part of the division value, and the second interval is a value obtained by rounding up the division value to a first decimal place.

4. The communication apparatus according to claim 3, wherein
when intervals between the plurality of sampling points are counted also including an interval between a lowest sampling point of the one of the symbol sequences and a highest sampling point of a subsequent one of the symbol sequences, a ratio between a number of the first intervals and a number of the second intervals is a ratio between a value obtained by subtracting a fractional part of the division value from 1 and the fractional part.

5. The communication apparatus according to claim 1, wherein
the resampling circuit detects edge positions in the one of the symbol sequences, each of the edge positions is a position where values of two adjacent among the symbols are different, and determines the plurality of sampling points of subsequent one of the symbol sequences, based on the edge positions.

6. The communication apparatus according to claim 5, wherein
the resampling circuit counts a left shift count value, which is, among candidates of the plurality of sampling points in the subsequent one of the symbol sequences, a number of the candidates each having an interval from one of the edge positions smaller than an interval threshold and being located on a left side of the one of the edge positions,
the resampling circuit counts a right shift count value, which is, among the candidates of the plurality of sampling points in the subsequent one of the symbol sequences, the number of the candidates each having the interval from one of the edge positions smaller than the interval threshold and being located on a right side of the one of the edge positions,
when the right shift count value is larger than the left shift count value, the resampling circuit determines the plurality of sampling points obtained by shifting the candidates to the right side as the plurality of sampling points of the subsequent one of the symbol sequences, and
when the left shift count value is larger than the right shift count value, the resampling circuit determines the plurality of sampling points obtained by shifting the candidates to the left side as the plurality of sampling points of the subsequent one of the symbol sequences.

7. The communication apparatus according to claim 6, wherein
the resampling circuit uses the plurality of sampling points of a current one of the symbol sequences as the candidates of the plurality of sampling points of the subsequent one of the symbol sequences.

8. The communication apparatus according to claim 6, wherein
when a lowest-side sampling point of the candidates of the plurality of sampling points is to be shifted from a lowest position back to a highest position of the one of the symbol sequences by shifting the candidates of the plurality of sampling points to the right side, the resampling circuit does not output one of the symbols at a highest-side sampling point of the plurality of sampling points in the subsequent one of the symbol sequences.

9. The communication apparatus according to claim 6, wherein
when a highest-side sampling point of the plurality of sampling points is to be shifted from a highest position to a lowest position of the subsequent one of the symbol sequences by shifting the candidates of the plurality of sampling points of the subsequent one of the symbol sequences to the left side, the resampling circuit also outputs one of the symbols at an additional sampling point located on a lower side of a lowest-side sampling point of a current one of the symbol sequences as the resampling data.

10. The communication apparatus according to claim 6, wherein
the resampling circuit shifts the candidates of the plurality of sampling points with a larger shift amount as an absolute value of a difference between the right shift count value and the left shift count value is larger.

11. The communication apparatus according to claim 6, wherein
the resampling circuit counts the right shift count value and the left shift count value in N (N is an integer of 2 or greater) of the symbol sequences,
when the right shift count value is larger than the left shift count value, the resampling circuit determines the plurality of sampling points obtained by shifting the candidates to the right side as the plurality of sampling points of each of M (M is a natural number smaller than N) subsequent ones of the symbol sequences, and
when the left shift count value is larger than the right shift count value, the resampling circuit determines the plurality of sampling points obtained by shifting the candidates to the left side as the plurality of sampling points of each of the M subsequent ones of the symbol sequences.

12. The communication apparatus according to claim 11, wherein
the resampling circuit determines a larger value as the N as amplitude of the first transmission signal is smaller.

13. The communication apparatus according to claim 11, wherein
when the resampling circuit determines that shift occurrence frequency of the plurality of sampling points is equal to or greater than an occurrence frequency threshold and shift directions of the plurality of sampling points are dispersed, the resampling circuit increases the N.

14. The communication apparatus according to claim 11, wherein
when shift directions of the plurality of sampling points are continuously same, the resampling circuit reduces the N.

15. A communication method comprising:
sampling a first transmission signal at a predetermined sampling frequency and sampling a second transmission signal at the predetermined sampling frequency by a sampling circuit, the first transmission signal input from a first external apparatus at a predetermined first transmission rate, the predetermined sampling frequency being higher than the predetermined first transmission rate and being not an integer multiple of the predetermined first transmission rate, the second transmission signal input from a second external apparatus at a second transmission rate the same as the predetermined sampling frequency;
sequentially outputting data output from the sampling circuit as parallel data;
in receiving the first transmission signal, converting the parallel data into symbol sequences each including a second integer number of symbols, the second integer being an integer obtained by multiplying a division value, which is obtained by dividing the predetermined sampling frequency by the predetermined first transmission rate, by a predetermined first integer; and
outputting the symbols of one of the symbol sequences at a plurality of sampling points respectively corresponding to a plurality of transmission symbols of the first transmission signal as resampling data of the first transmission signal.
